(19) United States
(12) Patent Application Publication
(10) Pub. No.: US 2026/0153387 A1
(43) Pub. Date: Jun. 4, 2026

(54) CORE-SHELL MICROPARTICLES FOR COLORIMETRIC SENSING AND METHODS FOR MAKING AND USING THE SAME

(71) Applicant: Trustees of Tufts College, MEDFORD, MA (US)

(72) Inventors: Fiorenzo G. Omenetto, Lexington, MA (US); Marco Lo Presti, Arlington, MA (US)

(21) Appl. No.: 19/236,599

(22) Filed: Jun. 12, 2025

Related U.S. Application Data
(63) Continuation of application No. PCT/US23/83853, filed on Dec. 13, 2023.
(60) Provisional application No. 63/387,108, filed on Dec. 13, 2022.

(51) Int. Cl. G01K 11/16; C08L 59/00; G01D 7/08; G01K 11/125; G01L 5/00

(52) U.S. Cl. CPC G01K 11/16; C08L 59/00; G01D 7/08; G01K 11/125; G01L 5/0052; C08L 2207/53

(57) ABSTRACT

Mechanochromic impact sensors, which can further include some temperature sensing capability, are disclosed. The sensors are based on core-shell vesicles having a core and a shell material layer at least party surrounding the core. The core includes crystalline polyacetylene. The shell material layer includes silk fibroin. The sensors provide impressively large dynamic range, thereby allowing quantitative measurement of blunt force impact across a new range of forces with a single sensor.

### CROSS-REFERENCE TO RELATED APPLICATION

This application claims benefit of and is a continuation of International Patent Application No. PCT/US2023/083853 (Attorney Docket. No. 2095.0587), filed Dec. 13, 2023, and entitled “CORE-SHELL MICROPARTICLES FOR COLORIMETRIC SENSING AND METHODS FOR MAKING AND USING THE SAME,” International Pub. No. WO2024129873, which is hereby incorporated by reference in its entirety for all purposes.

International Patent Application No. PCT/US2023/083853 is related to, claims priority to, and incorporates by reference for all purposes U.S. Provisional Patent Application No. 63/387,108 (Attorney Docket. No. 2095.0428), filed Dec. 13, 2022.

### STATEMENT REGARDING FEDERALLY FUNDED RESEARCH

This invention was made with government support under N00014-19-2399 awarded by the Department of Defense. The government has certain rights in the invention.

### BACKGROUND

Mechanical sensing is typically performed using electronic devices which require laboratory facilities to acquire and analyze data. Colorimetric sensors are cheaper and compatible with fast in-the-field detection of mechanical stimuli, but most colorimetric sensors display a narrow sensitivity range, are still expensive relatively to other sensing modalities, and have synthetic schemes that are difficult to scale up. Thus, there remains a need for developing colorimetric sensing materials and methods.

### SUMMARY

In an aspect, the present disclosure provides a colorimetric mechanochromic sensor that is responsive to a blunt for impact. The sensor includes one or more core-shell vesicles. Each of the one or more core-shell vesicles includes a core and a shell material layer. The core includes or is entirely composed of crystalline polyacetylene. The shell material layer at least party surrounds the core. The shell material layer includes silk fibroin. Each of the one or more core-shell vesicles has a first characteristic colorimetric property. The sensor is colorimetrically responsive to the blunt force impact by virtue of change in the crystal structure of the crystalline polyacetylene, thereby producing an observable and/or measurable change in the first characteristic colorimetric property for any of the one or more core-shell vesicles impacted by the blunt force impact. The first characteristic colorimetric property is selected from the group consisting of a color of the core-shell vesicle, a fluorescence spectrum of the core-shell vesicle, an optical anisotropy of the core-shell vesicle, a fluorescence anisotropy of the core-shell vesicle, a refractive index of the core-shell vesicle, an infrared spectrum of the core-shell vesicle, a near infrared spectrum of the core-shell vesicle, a morphology of the core-shell vesicle, a Raman spectrum of the core-shell vesicle, an x-ray diffraction spectrum of the core-shell vesicle, and combinations thereof.

In another aspect, the present disclosure provides a colorimetric thermal sensor that is responsive to temperature exceeding a predetermined temperature threshold. The sensor includes the basic structure of the mechanochromic sensor, but with a responsiveness to temperature and not a blunt force impact.

In yet another aspect, the present disclosure provides a colorimetric thermal and mechanical impact sensor. The sensor includes the basic structure of the mechanochromic sensor, but with additional responsiveness to temperature.

In a further aspect, the present disclosure provides precursors for each of these sensors, which can be converted into the sensor by selective application of ultraviolet light.

In another aspect, the present disclosure provides a device, such as helmet, including the sensors disclosed herein.

In yet another aspect, the present disclosure provides a system for recording and measuring mechanical impact. The system includes a camera, a processor, and a memory. The system is usable to quantify the mechanical impact of the sensors disclosed herein.

In yet a further aspect, the present disclosure provides a method of making a plurality of core-shell vesicles. The method includes mechanically agitating a water-based solution of silk fibroin and PCDA at an elevated temperature to produce a composition comprising a plurality of core-shell vesicles.

In another aspect, the present disclosure provides a method of analyzing an image to produce a mechanochromic impact map for an article comprising the sensors disclosed herein. The method includes: assessing a pre-impact image for the presence of the first characteristic colorimetric property; assessing a post-impact image for the presence of the first characteristic colorimetric property; generating the mechanochromic impact map from a difference in the first characteristic colorimetric property between a pre-impact image and a post-impact image.

### BRIEF DESCRIPTION OF THE DRAWINGS

The disclosure and the following detailed description of certain aspects thereof may be understood by reference to the following figures:

FIG. 1A is a schematic representation of the chemical synthesis of mechanochromic PDA molecules starting from PCDA, as described in Example 1. Upon UV activation, the aligned PCDA exhibits a color transition from transparent to blue, while upon mechanical stimulus the polydiacetylene (PDA) exhibits a mechanochromic transition from blue (blue phase) to red (red phase) due to the rearrangement of the molecular orbitals (bottom inset).

FIG. 1B is a schematic representation of the fabrication of polydiacetylene-silk fibroin (PDA-SF) mechanochromic sensors, as described in Example 1. The SF suspension and the PDA solution are mixed to induce the self-assembly of PDA-SF micrometer-size vesicles that can be cast on solid substrates to form mechanoresponsive sensors. A blue-to-red color transition occurs upon mechanical impact with the intensity of the transition being directly proportional to the impact force. The PDA-SF sensors can be conformally applied to curved surfaces and display a color change visible by the naked eye.

FIG. 2A is a plot of FTIR spectra of PCDA, PCDA-SF, and SF dried samples, as described in Example 1. The curves have been translated vertically for clarity.

FIG. 2B is a plot showing size distribution of PDA-SF vesicles with reported mean diameter (Mean), standard deviation (SD), and number of analyzed particles (N), as described in Example 1.

FIG. 2C is a top-view SEM image of an individual PDA-SF vesicle showing the core-shell structure with PDA sheets in the core of the vesicle and a surrounding conformal silk layer forming the shell, as described in Example 1.

FIG. 2D is a plot of PDA-SF solutions absorbance spectra as a function of wavelength for UV activation times of 0 s-180 min, as described in Example 1.

FIG. 2E is a plot of brightfield reflectance spectra as a function of wavelength of paper-based PDA-SF sensors for UV activation times of 0 s-180 min, as described in Example 1.

FIG. 2F is a macroscopic picture of PDA-SF solutions for UV activation times of 0 s-180 min, as described in Example 1. The color darkens from left to right, changing from a light blue to a deep blue, before eventually turning dark purple and reddish.

FIG. 2G is a set of brightfield reflectance micrographs of paper-based PDA-SF sensors for UV activation times of 0 s-180 min, as described in Example 1.

FIG. 3A is a set of macroscopic pictures of PDA-SF paper sensors, as described in Example 1.

FIG. 3B is a set of SEM images of PDA-SF vesicles before indentation (left), indented with a force of F=220 N (sampled from middle, dashed line circle in FIG. 3A), and indented with F=330 N (sampled from the right, dashed line circle in FIG. 3A), as described in Example 1.

FIG. 3C is a multispectral analysis of PDA-SF paper-based sensors showing the original bright field reflection micrograph (top row) and the corresponding reconstructed false-color image (bottom row) as function of indentation force (F=220-550 N), as described in Example 1. Color images can be provided to a patent examiner upon request. The grayscale images show the effect.

FIG. 3D are the corresponding normalized reflectance spectra for PDA-SF sensors as function of impact force, as described in Example 1.

FIG. 3E shows variation of the PDA-SF sensors colorimetric response as a function of force (F=0-550 N) evaluated as the ratio of the reflectance peak of the red phase (λ_{red phase}=570 nm) with the blue phase (λ_{blue phase}=651 nm), as described in Example 1.

FIG. 3F is a series of macroscopic pictures of PDA-SF paper sensors activated in the force range F=0-880 N, as described in Example 1.

FIG. 3G is a corresponding fluorescence response (λ_{Ex}=556 nm, λ_{Em}=650 nm) as a function of force (F=0-880 N) for the series of samples shown in FIG. 3F, as described in Example 1.

FIG. 4A is a schematic representation of the blue-to-red color transition of a mechanochromic PDA-SF sensor sticker in the shape of an elephant applied on a helmet (top). Macroscopic picture of the helmet after impact of a steel cylinder on the sensor (bottom left) and corresponding false-color composite multispectral image of the sticker showing the color transition in correspondence of the region of impact (bottom right, stripe).

FIG. 4B is a schematic representation of the blue-to-red color transition of a mechanochromic PDA-SF film applied on a polystyrene substrate upon walking (top). Macroscopic picture of the film (bottom left) and corresponding false-color composite multispectral image showing the color transition in correspondence of the region of impact of the sole of the shoe (bottom right).

FIG. 4C is a schematic representation of the blue-to-red color transition of a mechanochromic PDA-SF sensor film on a polystyrene substrate after the formation of concentric shock waves caused by the impact of two metallic spheres (top). False-color composite multispectral image of the film showing the color transition in correspondence of the region of impact (bottom).

FIG. 5A is a pair of SEM top-view images at low (left) and high (right) magnification for SF only, as described in Example 1.

FIG. 5B is a pair of SEM top-view images at low (left) and high (right) magnification for PDA only, as described in Example 1.

FIG. 5C is a pair of SEM top-view images at low (left) and high (right) magnification for PDA-SF vesicles, as described in Example 1.

FIG. 5D is a pair of SEM top-view images at low (left) and high (right) magnification for PDA-DMPC vesicles, as described in Example 1.

FIG. 6 is a schematic representation of the mechanical setup used to activate the mechanochromic paper-based sensors, as described in Example 1. The dropping height h is measured from the top of the sample to the bottom of the stainless-steel dart before dropping.

FIG. 7 is a schematic representation of a scaled up process, as described in Example 2.

FIG. 8 is a series of images showing medium-sized vesicles coating on textile at a variety of concentrations, as described in Example 3.

FIG. 9 is a series of images showing small-sized vesicles coating on textile at a variety of concentrations, as described in Example 3.

FIG. 10 is a series of micrographs of indentations made on a mechanochromic textile, as described in Example 3.

FIG. 11 is a series of images, some magnified, of an insole coated with medium-sized vesicles after varying amounts of walking activity, as described in Example 3.

FIG. 12 is a pair of images showing a textile functionalized with the disclosed sensors before (left) and after (right) rinsing in water for 1 hour, as described in Example 3.

FIG. 13A is a series of increasing magnification images of a shirt functionalized with the disclosed sensors, as described in Example 3.

FIG. 13B is a series of images of worn and frayed climbing rope including the disclosed sensors, as described in Example 3.

FIG. 13C is a before and after image of a shirt having the disclosed sensors configured as a blastometer, as described in Example 3.

FIG. 13D is a series of images of orthopedic inserts, as described in Example 3.

### DETAILED DESCRIPTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

The present disclosure provides a colorimetric mechanochromic sensor and methods of making and using the same. In some cases, the sensors have impact sensing and/or thermal sensing properties. The disclosure also provides precursors to the sensors, which are physically similar, but which have not been activated yet, typically by ultraviolet light. The sensors can detect blunt force impact and/or rise in temperature. The sensor can be embedded in a carrier material to provide a broader material having sensing capabilities. This broader material can take a variety of forms, including articles, helmets, containers, suitcases, automotive parts, and the like. The disclosure further provides a system for recording and measuring mechanical impact using the disclosed sensor.

### Definitions

In this application, unless otherwise clear from context, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; and (iv) the terms “about” and “approximately” are used as equivalents and may be understood to permit standard variation as would be understood by those of ordinary skill in the art; and (v) where ranges are provided, endpoints are included.

Approximately: as used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Composition: as used herein, may be used to refer to a discrete physical entity that comprises one or more specified components. In general, unless otherwise specified, a composition may be of any form—e.g., gas, gel, liquid, solid, etc. In some embodiments, “composition” may refer to a combination of two or more entities for use in a single embodiment or as part of the same article. It is not required in all embodiments that the combination of entities result in physical admixture, that is, combination as separate co-entities of each of the components of the composition is possible; however many practitioners in the field may find it advantageous to prepare a composition that is an admixture of two or more of the ingredients in a pharmaceutically acceptable carrier, diluent, or excipient, making it possible to administer the component ingredients of the combination at the same time.

Hydrophilic: as used herein, the term “hydrophilic” and/or “polar” refers to a tendency to mix with, or dissolve easily in, water.

Hydrophobic: as used herein, the term “hydrophobic” and/or “non-polar”, refers to a tendency to repel, not combine with, or an inability to dissolve easily in, water.

Improve, increase, or reduce: as used herein or grammatical equivalents thereof, indicate values that are relative to a baseline measurement, such as a measurement in a similar composition made according to previously known methods.

Macroparticle: as used herein, the term “macroparticle” refers to a particle having a diameter of at least 1 millimeter. In some embodiments, macroparticles are micelles in that they comprise an enclosed compartment, separated from the bulk solution by a micellar membrane, typically comprised of amphiphilic entities which surround and enclose a space or compartment (e.g., to define a lumen). In some embodiments, a micellar membrane is comprised of at least one polymer, such as for example a biocompatible and/or biodegradable polymer. In some embodiments, a population of particles is considered a population of macroparticles if the mean diameter of the population is equal to or greater than 1 millimeter.

Microparticle: as used herein, the term “microparticle” refers to a particle having a diameter between 1 micrometer and 1 millimeter. In some embodiments, microparticles are micelles in that they comprise an enclosed compartment, separated from the bulk solution by a micellar membrane, typically comprised of amphiphilic entities which surround and enclose a space or compartment (e.g., to define a lumen). In some embodiments, a micellar membrane is comprised of at least one polymer, such as for example a biocompatible and/or biodegradable polymer. In some embodiments, a population of particles is considered a population of microparticles if the mean diameter of the population is between 1 micrometer and 1 millimeter.

Nanoparticle: as used herein, the term “nanoparticle” refers to a particle having a diameter of less than 1000 nanometers (nm). In some embodiments, a nanoparticle has a diameter of less than 300 nm, as defined by the National Science Foundation. In some embodiments, a nanoparticle has a diameter of less than 100 nm as defined by the National Institutes of Health. In some embodiments, nanoparticles are micelles in that they comprise an enclosed compartment, separated from the bulk solution by a micellar membrane, typically comprised of amphiphilic entities which surround and enclose a space or compartment (e.g., to define a lumen). In some embodiments, a micellar membrane is comprised of at least one polymer, such as for example a biocompatible and/or biodegradable polymer. In some embodiments, a population of particles is considered a population of nanoparticles if the mean diameter of the population is equal to or less than 1000 nm.

Pure: as used herein, a material, additive, and/or entity is “pure” if it is substantially free of other components. For example, a preparation that contains more than about 90% of a particular agent or entity is typically considered to be a pure preparation. In some embodiments, an agent or entity is at least 91%, at least 92%, at least 93%, at least 94%, at least 95%, at least 96%, at least 97%, at least 98%, or at least 99% pure.

Reference: as used herein describes a standard or control relative to which a comparison is performed. For example, in some embodiments, a material, article, additive, entity or other sample, sequence or value of interest is compared with a reference or control material, article, additive, entity or other sample, sequence or value. In some embodiments, a reference or control is tested and/or determined substantially simultaneously with the testing or determination of interest. In some embodiments, a reference or control is a historical reference or control, optionally embodied in a tangible medium. Typically, as would be understood by those skilled in the art, a reference or control is determined or characterized under comparable conditions or circumstances to those under assessment. Those skilled in the art will appreciate when sufficient similarities are present to justify reliance on and/or comparison to a particular possible reference or control.

Solid form: as is known in the art, many chemical entities (in particular many organic molecules and/or many small molecules) can adopt a variety of different solid forms such as, for example, amorphous forms and/or crystalline forms (e.g., polymorphs, hydrates, solvates, etc). In some embodiments, such entities may be utilized as a single such form (e.g., as a pure preparation of a single polymorph). In some embodiments, such entities may be utilized as a mixture of such forms.

Substantially: as used herein, the term “substantially” refers to the qualitative condition of exhibiting total or near-total extent or degree of a characteristic or property of interest. One of ordinary skill in the biological arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

### Colorimetric Mechanochromic Sensors

The detection of mechanical impact on surfaces is relevant for many fields, as it allows measurements such as the detection of concussions in sports and the monitoring of materials' integrity. Several strategies are being investigated to meet this sensing need, yet they often rely on electronic platforms, they do not provide an easy readout to untrained users, and there are limitations in the formats in which the sensors can be shaped and in the scale at which they can be produced. A simple colorimetric distributed reporting of mechanical impact would be advantageous, as it would provide a visible, easy-to-read optical response upon application of mechanical force. Chromic polymers such as polydiacetylene (PDA) have been extensively used as thermal sensors but, despite their abundant characterization, lack of sensitivity and sufficient color variation have, so far, limited their use as sensors for practical applications. Here, we propose the self-assembly of PDA with regenerated silk fibroin protein (SF) in core-shell vesicles which display an irreversible mechanochromic transition from blue to red upon impact that enables tracking the impact history of the material on which they are applied to. The characteristics of the PDA-SF suspension lend themselves to the long-term stability of the self-assembled vesicles, versatility in the sensor format, and straightforward scaling up. PDA-SF sensors are calibrated and characterized using multispectral imaging and colorimetric (RGB) analysis; the colorimetric response is proportional to the impact energy with a sensing range of 110-770 N. A series of prototypes is then presented to demonstrate the versatility of the PDA-SF mechanochromic sensors for the distributed detection of concussive impacts for sport applications. These chromophore-protein assemblies find utility as easy-to-use, impact memory mechanochromic sensors visible to the naked eye, measurable by spectral and RGB analysis, and suitable for large-scale distributed sensing applications.

The present disclosure provides a colorimetric mechanochromic sensor. As discussed elsewhere herein, these sensors can have impact sensing and/or thermal sensing capabilities. The mechanical sensing properties in particular are exceptionally impressive when compared with existing impact sensing technologies. Specifically, the impact threshold and dynamic range of the disclosed sensors are amazingly improved relative to the current state of the art. As used herein, the term impact threshold refers to the minimum impact that provides a detectable signal. As used herein, the term dynamic range refers to the range of impacts across which the sensors can provide a quantitative signal (i.e., different impacts within the dynamic range provide different qualitative outputs, so the impact can be quantified within the dynamic range). When combined, the impact threshold and dynamic range can provide a maximum impact to which the sensor is capable of sensing, namely, the impact threshold plus the dynamic range (e.g., if the impact threshold is 110 N and the dynamic range is 590 N, then the maximum sensed impact is 700 N).

The colorimetric mechanochromic sensor includes one or more core-shell vesicles. Each of the one or more core-shell vesicles includes: a) a crystalline polyacetylene core and b) a shell material layer including silk fibroin. Each of the one or more core-shell vesicles has a first characteristic colorimetric property. Without wishing to be bound by any particular theory, it is believed that the sensor is colorimetrically responsive to a blunt force and/or change in temperature by virtue of change in the crystal structure of the crystalline polyacetylenes core, thereby producing an observable or measurable change in the first characteristic colorimetric property for any of the one or more core-shell vesicles impacted by the blunt force impact. The first characteristic colorimetric property may be selected from the group consisting of: a color of the core-shell vesicle, a fluorescence spectrum of the core-shell vesicle, an optical anisotropy of the core-shell vesicle, a fluorescence anisotropy of the core-shell vesicle, a refractive index of the core-shell vesicle, an infrared spectrum of the core-shell vesicle, a near infrared spectrum of the core-shell vesicle, a morphology of the core-shell vesicle, a Raman spectrum of the core-shell vesicle, an x-ray diffraction spectrum of the core-shell vesicle, and combinations thereof.

The impact threshold of these sensors is important for determining the specific application. The impact threshold needs to be aligned with the sensing needs. In some cases, the impact threshold is between 200 N and 500 N.

The dynamic range is also important for determining the specific application. The dynamic range needs to be aligned with the sensing needs. For example, in some cases, there is a single impact threshold that is important and whether the threshold was exceeded is all that matter, but in other cases, it can be important to know how much above an impact threshold a given impact was. In the former cases, the dynamic range can be quite small without major incident. In the latter cases, the dynamic range is critical, as it allows quantitative impact sensing. A large dynamic range impact sensor has been long evasive, so a prominent need in the field exists for an impact sensor with significant dynamic range.

In instances where infrared signals are used, the impact threshold is generally lower and the dynamic range is generally larger. In cases where infrared signals are used, the impact threshold can be between 200 N and 350 N. In cases where infrared signals are used, the dynamic range can be at least 500 N, at least 590 N, or at least 600 N.

In cases where visible signals are used, the impact threshold is generally higher and the dynamic range is generally smaller. In cases where visible signals are used, the impact threshold can be between 350 N and 500 N. In cases where visible signals are used, the dynamic range can be at least 150 N, at least 200 N, or at least 220 N.

Importantly, the sensors of the present disclosure can provide two different impact thresholds, one for visible detection and one for fluorescence detection, and two different dynamic ranges, one for visible detection and one for fluorescence detection.

### Core

The core of the one or more core-shell vesicles is tailored for the sensing capabilities articulated herein. The core of the vesicles includes crystalline polyacetylene. Polyacetylene refers to a class of polymers with a repeating monomer of [C₂H₂]ₙ. In some cases, the core may include polydiacetylenes (PDAs), a class of polymers where the repeating monomer is C₄H₂. In other cases, the core may include 10,12 pentacosadiynoic acid (PCDA).

The core can be solid or liquid, though the core is typically in a solid form. In some cases, particularly in the precursor, the core is amorphous. In some cases, particularly after the precursor has been activated to make the sensor, the core is crystalline. In certain situations, the core is a single crystal.

It should be appreciated that certain aspects of the core are consistent between the precursor and the sensor itself (e.g., physical dimensions), whereas other aspects are changed by the UV activation that converts the precursor into an active sensor (e.g., crystallinity). A skilled artisan will recognize the areas of agreement and the areas of distinction.

Without wishing to be bound by any particular theory, the hydrophobic polydiacetylene chains assemble in the vesicle core by aligning in an orderly fashion next to one another. Following UV activation, the chains bind covalently to each other by I-4-type addition. The enhanced packing of the chains in the core is suggested by the observation that the same concentration is producing a higher absorbance in blue wavelengths for silk microspheres when compared with DMPC embodiments.

### Shell

The shell of the one or more core-shell vesicles serves a variety of purposes, including protection of the core and providing mechanical stability to the core and the broader structure. In certain situations, the shell does not alter the colorimetric response of the core while still providing chemical and/or mechanical encapsulation (i.e., if it were possible to suspend a core without a shell in space, the colorimetric response may be similar).

In certain cases, the encapsulation is partial encapsulation of the core. In other cases, the encapsulation is complete encapsulation where the shell forms a continuous layer around the core. The shell can be single or multi-lamellar.

The shell can provide certain material properties to the sensor and precursor, which can provide advantageous effect. For example, the shell can be amphiphilic, which can provide certain advantageous hydrophobic and hydrophilic environments to the sensor and precursor. In some cases, the shell can withstand being heated to and in some cases above the glass transition temperature of the core material. The material of the shell can act as a surfactant in the self-assembly of the core-shell vesicle structure by undergoing a phase transition. The core can provide shielding to the crystalline polyacetylene core from excessive ultraviolet light exposure. In cases where shielding is present, the mechanism of shielding may include absorption, reflection, refraction, scattering, or wavelength-dependent transmission.

In one case, the shell layer material is silk fibroin. As used herein, “silk fibroin” refers to silk fibroin protein whether produced by silkworm, spider, or other insect, or otherwise generated (Lucas et al., Adv. Protein Chem., 13:107-242 (1958)). Any type of silk fibroin can be used in different embodiments described herein. Silk fibroin produced by silkworms, such as Bombyx mori, is the most common and represents an earth-friendly, renewable resource. For instance, silk fibroin used in a silk film may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants, and variants thereof, that can be used. Sec, e.g., WO 97/08315 and U.S. Pat. No. 5,245,012, each of which is incorporated herein by reference in their entireties.

The molecular weight of the silk fibroin can be varied to adjust some properties of the sensors, though functional sensors were made with all molecular weights tested. In some cases, the weight average molecular weight of the silk fibroin was 150 kDa to 40 kDa, though most of the experiments were conducted with a weight average molecular weight of 150 kDa.

### Core-Shell Vesicles

As briefly mentioned above, the core and the shell combine to form a core-shell vesicle. The colorimetric mechanochromic sensor includes one or more core-shell vesicles. In most cases, the colorimetric mechanochromic sensor includes a plurality of core-shell vesicles. The physical structure of the shell itself can be referred to herein as a shell material layer.

In an aspect, the shell material layer defines an inner hydrophobic pocket and an outer hydrophilic surface (i.e., a unilamellar vesicle). In these cases, the crystalline polyacetylene core is located in the hydrophobic pocket. In other aspects, the shell material may form a multilamellar core-shell vesicular structure where there are multiple concentric hydrophobic pockets. In this embodiment the crystalline polyacetylene core may be found in any one or more of the multiple concentric hydrophobic pockets.

The one or more core-shell vesicles can have a mass ratio of the crystalline polyacetylene core to the shell material layer of between 1:1000 and 100:1. In some cases, the core-shell vesicles may have a mass ratio of the crystalline polyacetylene core to the shell material layer between 1:100 and 100:1, 1:10 and 100:1, or between 1:1 and 100:1.

The crystalline polyacetylene core can make up between 60% and 98%, between 50% and 98%, between 40% and 98%, or between 30% and 98% of the core-shell vesicle diameter. The shell material layer can make up between 2% and 40%, between 2% and 50%, between 2% and 60%, or between 2% and 70% of the core-shell vesicle diameter.

Each core-shell vesicle can have a diameter of between 0.05 μm and 1 mm. In another aspect, the core-shell vesicles may have a mean diameter of between 0.05 micrometers and 1 millimeter. Examples of suitable core-shell vesicle diameters include, but are not limited to, a diameter of: between 1 and 10 micrometers, between 2 micrometers and 8 micrometers, between 1.8 micrometers and 8.4 micrometers, between 5 micrometers and 10 micrometers, between 10 micrometers and 15 micrometers, between 1 micrometer and 20 micrometers, between 1 micrometer and 30 micrometers, between 4 micrometers and 50 micrometers, between 4 micrometers and 100 micrometers, between 4 micrometers and 200 micrometers, or between 4 micrometers and 300 micrometers. In some cases, each diameter or the mean diameter can be at least 0.05 μm, at least 0.10 μm, at least 0.20 μm, at least 0.25 μm, at least 0.5 μm, at least 1.0 μm, at least 3.0 μm, at least 3.5 μm, at least 3.8 μm, at least 4.0 μm, at least 4.5 μm, at least 4.75 μm, at least 5.0 μm, at least 5.5 μm, at least 5.6 μm, at least 6.0 μm, at least 6.5 μm, at least 6.8 μm, at least 7.0 μm, at least 7.5 μm, at least 7.75 μm, at least 8.0 μm, at least 8.5 μm, at least 8.6 μm, at least 9.0 μm, at least 9.5 μm, at least 9.7 μm, at least 10.0 μm, at least 10.5 μm, at least 10.75 μm, at least 11.0 μm, at least 11.5 μm, at least 11.75 μm, at least 12.0 μm, at least 12.5 μm, at least 12.6 μm, at least 13.0 μm, at least 13.5 μm, at least 13.8 μm, at least 14.0 μm, at least 14.5 μm, at least 14.7 μm, at least 15.0 μm, at least 15.5 μm, at least 15.75 μm, at least 16.0 μm, at least 16.5 μm, at least 16.6 μm, at least 17.0 μm, at least 17.5 μm, at least 17.8 μm, at least 18.0 μm, at least 18.5 μm, at least 18.7 μm, at least 19.0 μm, at least 19.5 μm, at least 19.75 μm, at least 20.0 μm, at least 25.0 μm, at least 30.0 μm, at least 35.0 μm, at least 40.0 μm, at least 45.0 μm, at least 50.0 μm, at least 55.0 μm, at least 60.0 μm, at least 65.0 μm, at least 70.0 μm, at least 75.0 μm, at least 80.0 μm, at least 85.0 μm, at least 90.0 μm, at least 95.0 μm, 100 μm, at least 150 μm, at least 200 μm, at least 250 μm, at least 300 μm, at least 350 μm, at least 400 μm, at least 450 μm, at least 500 μm, at least 600 μm, at least 700 μm, at least 800 μm, or at least 900 μm. In some cases, each diameter or the mean diameter can be at most 1 mm, at most 900 μm, at most 800 μm, at most 750 μm, at most 700 μm, at most 650 μm, at most 600 μm, at most 575 μm, at most 550 μm, at most 525 μm, at most 500 μm, at most 450 μm, at most 400 μm, at most 360 μm, at most 350 μm, at most 320 μm, at most 300 μm, at most 240 μm, at most 200 μm, at most 175 μm, at most 150 μm, at most 125 μm, at most 100 μm, at most 92.5 μm, at most 90.0 μm, at most 87.5 μm, at most 85.0 μm, at most 83.0 μm, at most 80.0 μm, at most 75.0 μm, at most 71.5 μm, at most 70.0 μm, at most 67.5 μm, at most 65.0 μm, at most 60.0 μm, at most 55.0 μm, at most 50.0 μm, at most 48.0 μm, at most 45.0 μm, at most 43.5 μm, at most 40.0 μm, at most 37.0 μm, at most 35.0 μm, at most 32.5 μm, at most 30.0 μm, at most 27.5 μm, at most 25.0 μm, at most 22.5 μm, at most 20.0 μm, at most 17.5 μm, at most 15.0 μm, at most 13.0 μm, at most 12.5 μm, at most 11.0 μm, at most 10.0 μm, or at most 5.0 μm.

In another aspect, at least one or more core-shell vesicles may have a negative zeta potential. In one embodiment, at least 5%, at least 10%, at least 15%, at least 20%, at least 25%, at least 30%, at least 40%, at least 50%, at least 60%, at least 70%, at least 75%, at least 80%, at least 85%, at least 90%, at least 95%, or each of the one or more core-shell vesicles has a negative zeta potential. In some cases, at least one of the one or more core-shell vesicles has a zeta potential of between 0 mV and −100 mV, including but not limited to, a zeta potential of between −20 mV and −100 mV, between −25 mV and −100 mV, between −30 mV and −60 mV, between −40 mV and −60 mV, or between −45 mV and −55 mV.

In some embodiments, the core-shell vesicles are spherical, ellipsoids, pear-shaped, cup-shaped, budded, elongated, or angular. In some embodiments at least 50%, at least 75%, at least 90% or approximately 100% of the one or more vesicles is spherical in shape. In some cases, they core-shell vesicles are spherical. In some cases, they are exceptionally spherical, when compared with other structure that have been made from similar core materials with similar sensing goals. Microfluidic synthesis (e.g., Shimanovich, Ulyana, et al. “Silk micrococoons for protein stabilisation and molecular encapsulation.” Nature communications 8.1 (2017): 1-9, which is incorporated herein in its entirety by reference for all purposes) is one specific approach to providing non-spherical core-shell vesicles. In some cases, the core-shell vesicles may have a ratio of minimum diameter to maximum diameter (e.g., inverse aspect ratio) of between 0.75 and 1.0, including between 0.90 and 1.0 or between 0.95 and 1.0. In many cases, the core-shell vesicles will exist in some degree of a statistical distribution, and in these cases, core-shell vesicles may have an average ratio of minimum diameter to maximum diameter of at least 0.9, at least 0.925, or at least 0.95.

### Colorimetric Mechanochromic Sensor Precursors

The present disclosure also provides a colorimetric mechanochromic sensor precursor. The colorimetric mechanochromic sensor precursor is structurally quite similar to the sensor itself, but it has not yet been activated by UV light to fully activate its sensing capabilities. Without wishing to be bound by any particular theory, it is believed that the precursor will be more shelf-stable and more resistant to external conditions, such as exposure to background UV radiation, thereby enabling broader distribution and use of the sensors, without requiring localized facilities that would be necessary if the product needed to be distributed with its fully sensing capabilities activated.

The precursor includes one or more core-shell vesicles that, aside from lacking the polymerization that is induced by the application of UV light, are identical to the vesicles in the sensors. The precursor includes one or more core-shell vesicles comprising: a) an acetylene core comprising acetylene monomers; and b) a shell material layer at least partly surrounding the acetylene core, the shell material layer including silk fibroin.

Applying an appropriate dose of ultraviolet (UV) light to the mechanochromic sensor precursor produces the colorimetric mechanochromic sensor described above. In some cases, the UV light is applied for no less than 2 seconds to no greater than 6 hours. In some cases, no less than 1% and up to 100% of the core-shell vesicles in the colorimetric mechanochromic precursor are converted to the core-shell vesicles of the mechanochromic sensor. In an aspect, the mechanochromic sensor precursor produces the colorimetric mechanochromic sensor when treated with a UV dose of no less than 1,000 mJ/cm² and no more than 60,000 mJ/cm². In a specific, non-limiting example, about 50% of the core-shell vesicles in the colorimetric mechanochromic precursor are converted to the mechanochromic sensor after 3 hours of exposure to a UV dose of 27,000 mJ/cm².

In one embodiment, without wishing to be bound by any particular theory, the preparation of the colorimetric mechanochromic sensor precursor requires first a self-alignment of the polyacetylene or polydiacetylene monomer that polymerizes through the 1,4-addition by UV exposure (λ=254 nm), which generates the polymeric backbone with alternating C═C and C≡C bonds (ene-yne). It is believed that the heating and mixing processes described herein may form this self-alignment of monomers, which can advantageously be used to prepare precursors, which in turn can be converted into sensors with the application of UV light.

### A First Characteristic Colorimetric Property

The sensors described herein operate on the basis of a colorimetric property that is characteristic and changeable upon impact and/or change in temperature. Each of the one or more core-shell vesicles has a first characteristic colorimetric property.

In some cases, the first characteristic colorimetric property is selected from the group consisting of a color of the core-shell vesicle, a fluorescence spectrum of the core-shell vesicle, an optical anisotropy of the core-shell vesicle, a fluorescence anisotropy of the core-shell vesicle, a refractive index of the core-shell vesicle, an infrared spectrum of the core-shell vesicle, a near infrared spectrum of the core-shell vesicle, a morphology of the core-shell vesicle a Raman spectrum of the core-shell vesicle, an x-ray diffraction pattern of the core-shell vesicle, and combinations thereof. In one embodiment, the first characteristic colorimetric property is derived from a reflectance color spectrum of at least a portion of the colorimetric mechanochromic sensor.

In some embodiments, the first characteristic colorimetric property is shelf stable (i.e., no measurable change in first characteristic colorimetric property). In this embodiment, the core-shell vesicles can remain on a shelf for at least one year at average room temperature (55-95° F.), average relative humidity (15-75%), and ambient warehouse light levels (2-35 lumens per square foot at the storage surface) without undergoing measurable change in the first characteristic colorimetric property.

In another embodiment, the first characteristic colorimetric property is stable (i.e., no measurable change in first characteristic colorimetric property) towards unselective stimuli. In one embodiment, the unselective stimuli can be UV light or sunlight.

### Blunt Force Impact

The present disclosure provides for a colorimetric mechanochromic sensor that is responsive to a blunt force impact. In certain cases, the blunt force impact producing the observable and/or measurable change is above an impact threshold of between 50 N and 350 N. The sensor can have a dynamic range of between 200 N and 700 N. For example, the blunt force impact producing the observable and/or measurable change can result from a force of between 50 N and 750 N, between 110 N and 700 N, between 110 N and 400 N, between 110 N and 300 N, between 110 N and 200 N, between, 110 M and 150 N, between 110 M and 115 N, between 600 N and 700 N, between 500 N and 600 N, between 400 N and 500 N, between 300 N and 400 N, between 200 N and 300 N, between 200 N and 500 N, between 220 N and 440 N, and between 300 N and 600 N.

In some embodiments, the blunt force impact producing the observable and/or measurable change is an impact threshold of between 50 N and 200 N, including 110 N, and a dynamic range of between 400 N and 700 N, including 590 N, when the first characteristic colorimetric property is the fluorescence spectrum of the core-shell vesicle. The inventors unexpectedly discovered a previously unachievable dynamic range using fluorescence measurements and the disclosed sensor. Previously, quantitative sensors with this impressive dynamic range were not achievable, to the best of the inventors' knowledge.

In some embodiments, the blunt force impact producing the observable and/or measurable change is an impact threshold of between 200 and 250 N, including 220 N, and a dynamic range of between 200 and 250 N, including 220 N, when the first characteristic colorimetric property may be the color of the core-shell vesicle.

### Change in Crystalline Structure of the Polyacetylene Core

The present disclosure provides for a colorimetric response of the sensor to blunt force impact and/or temperature by virtue of a change in the crystal structure of the crystalline polyacetylene core, thereby producing an observable and/or measureable change in the first characteristic property for any of the one more core-shell vesicles impacted by the blunt force impact or temperature.

In one embodiment, mechanochromism in polyacetylene core occurs when a specific amount of mechanical energy or average kinetic energy is delivered to the polymer backbone causing the disruption of the π-orbitals and the consequent colorimetric transition.

Observable and/or Measurable Change

The present disclosure provides for a colorimetric mechanochromic sensor or precursor that is responsive to a blunt force impact. The blunt force impact produces an observable and/or measurable change. In some cases, the observable and/or measurable change may be measurable. In some cases, a measurable change may be quantifiable. In other cases, the observable/measurable change may not be quantifiable. In some cases, the observable and/or measurable change may be observable. In some cases, the observable change may be the color of the core-shell vesicle. The observable change may be observable by the human eye. In other cases, the observable change is not observable by a human eye.

### Carrier Material

The present disclosure provides for colorimetric mechanochromic sensor or precursor including core-shell vesicles embedded in a carrier material. The carrier material is intended to aid in dispersing the core-shell vesicles onto a surface or material. The carrier may be liquid (e.g., an aqueous solution), a solid, or a lyophilized solid. In some cases, the carrier may be a non-aqueous polar solvent or a non-aqueous nonpolar solvent.

The carrier material may be a material that is applied to or incorporated into another device or article. For example, the carrier material may be an adhesive sticker where the core-shell vesicles are applied to adhesive sticker and the sticker is then adhered to the device or article. The sticker may be a vinyl sticker or a paper sticker. In other cases, the carrier material that the core-shell vesicles may be applied to can be paper, including cellulosic paper, filter paper or cardstock paper. In other cases, the core-shell vesicles may be applied to polystyrene sheet. In other cases, the core-shell vesicles may be applied to wood, leather, polypropylene, polyester, cardboard, closed cell foam, open cell foam, metal, polystyrene, medium-impact polystyrene resin, expanded polystyrene (EPS), polyurethane, polyurethane foam, fiberglass, acrylonitrile butadiene styrene, high density polyethylene, polycarbonate, polyvinylchloride, vinyl nitril foam, viscoelastic foam, composite fibers, carbon fiber, thermoplastic rubber, ethyl vinyl acetate, or high-resistance thermoplastic or any combination thereof. In other cases, the core-shell vesicles may be applied to cloth used to construct articles of clothing. In some cases the cloth may include cotton, wool, polyester, silk, rayon, nylon, linen, modal, elastane, leather, acetate, mohair, viscose, polyvinyl chloride, bamboo, hemp, polybenzimidazole fiber, ultra-high-molecular-weight polyethylene, polyphenylene sulfide, polylactic acid, polyhydroquinone-diimidazopyridine, modacrylic, olefin, acrylic, aromatic polyamide, poly(p-phenylene-2,6-benzobisoxazole), or any combination thereof.

In one particular example, a sensor-infused cardboard is contemplated. The sensors or precursors can be integrated within the material of the cardboard or applied to a surface.

In some cases, the core-shell vesicles are applied to the carrier material by drop casting, spin coating, dip coating, electrostatically attracting, doctor blading, transfer printing, ink jet printing, spraying, by Langmuir-Blodgett (LB) methodology, or by other methods known by skilled artisans to produce similar results.

### Colorimetric Thermal Sensors and Precursors

The present disclosure provides a colorimetric thermal sensor and a colorimetric thermal sensor precursor. The colorimetric thermal sensor and precursor includes one or more core-shell vesicles as described above.

In general, the thermal sensing properties of the disclosed sensor are unidirectional, such that reaching a given temperature for a given length of time causes an irreversible change. In general, the sensors disclosed herein are stable at temperatures of up to 30° C. or 35° C. or higher. The sensors disclosed herein rapidly change color in a few seconds when exposed to 60° C. In general, the sensors disclosed herein have a temperature threshold of between 45° C. and 60° C., including but not limited to, between 48° C. and 55° C. Without wishing to be bound by any particular theory, it is believed that the sensors disclosed herein may give a quantitative measure of temperature as the temperature approaches the threshold temperature. In other words, there may be a first threshold temperature, above which small changes proportional to the change in temperature may occur, and a second temperature threshold, above which a larger change in color occurs.

### Colorimetric Thermal-Mechanochromic Sensors and Precursors

The present disclosure provides a colorimetric thermal-mechanochromic sensor and a colorimetric thermal-mechanochromic sensor precursor. The colorimetric thermal-mechanochromic sensor and precursor includes one or more core-shell vesicles as described above. The combined performance of this sensor allows for a determination of whether either of the following has occurred: a) a mechanical impact; or b) a temperature exceeding a threshold.

### Devices

The present disclosure provides for a device including the colorimetric mechanochromic sensor, the colorimetric mechanochromic sensor precursor, the colorimetric thermal sensor, the colorimetric thermal sensor precursor, the colorimetric thermal-mechanochromic sensor, and/or the colorimetric thermal-mechanochromic sensor precursor. In some cases, these sensors and precursors may be adapted to sense an impact on a portion of the device. In other cases, the sensors and precursors may be adapted to sense a temperature on a portion of the device.

In some situations, the core-shell vesicles are applied to the device in advance of activation with UV light (i.e., as the precursor) and in other situations, the core-shell vesicles are applied to the device after activation with UV light (i.e., as the sensor). It is contemplated that a mixture of activated sensors and not-yet-activated precursors can be provided and used to facilitate some immediate sensing ability that is coupled with advantageous storage stability/ability to activate precursors into newly-active sensors.

The core-shell vesicles may be applied to polystyrene, wood, leather, polypropylene, polyester, cardboard, closed cell foam, open cell foam, metal, polystyrene, medium-impact polystyrene resin, expanded polystyrene (EPS), polyurethane, polyurethane foam, fiberglass, acrylonitrile butadiene styrene, high density polyethylene, polycarbonate, polyvinylchloride, vinyl nitril foam, viscoelastic foam, composite fibers, carbon fiber, thermoplastic rubber, ethyl vinyl acetate, or high-resistance thermoplastic or any combination thereof.

In some case, the device may be a golf club with a striking face, where the striking face can comprise the sensors or precursors described herein.

### Helmets

In some cases, the device may be a helmet (e.g., for football, for bicycle riding, for motorcycle riding, for rock climbing, for hockey playing, baseball playing, or for safety). In some cases, the helmet may be dimensioned to fit the cranium of a human baby, having cranial dimensions falling within two standard deviations of the mean of a statistically significant population of human babies. In some cases, the helmet may be dimensioned to fit the cranium of a human infant, having cranial dimensions falling within two standard deviations of the mean of a statistically significant population of human infant. In some cases, the helmet may be dimensioned to fit the cranium of a human toddler, having cranial dimensions falling within two standard deviations of the mean of a statistically significant population of human toddlers. In some cases, the helmet may be dimensioned to fit the cranium of a human child, having cranial dimensions falling within two standard deviations of the mean of a statistically significant population of human children. In some cases, the helmet may be dimensioned to fit the cranium of a human adult, having cranial dimensions falling within two standard deviations of the mean of a statistically significant population of human adults.

In some cases, the colorimetric mechanochromic sensor or precursor may be located in a plastic portion of the helmet, including the rigid shell of the helmet. In some cases, the colorimetric mechanochromic sensor or precursor may be located in a padded portion of the helmet, such as the foam comfort padding or the impact absorbing liner (i.e., protective padding, expanded polystyrene foam). The colorimetric mechanochromic sensor or precursor may be located in a liner located between the cranium and the impact absorbing liner. In one exemplary aspect, the colorimetric mechanochromic sensor or precursor may be located in a Multi-directional Impact Protection System (MIPS®) wherein the MIPS® Brain Protection System (BPS) allows the head to move inside the helmet which may reduce the harmful rotational motion otherwise transferred to the brain. In some cases, the colorimetric mechanochromic sensor or precursor may be located in a non-foam impact absorbing liner of the helmet. In a certain example, the colorimetric mechanochromic sensor or precursor may be located in a collapsible cellular structure that lines the inside of the helmet designed to absorb linear and rotational energy that occur during certain helmet impacts.

In some cases, the colorimetric mechanochromic sensor or precursor may be located in the retention system of the helmet, such as a chin strap, strap divider, or buckle. The colorimetric mechanochromic sensor or precursor may be located in a chin guard or neck curtain. The colorimetric mechanochromic sensor or precursor may be located in the fit system of the helmet which tightens the helmet around a cranium.

Without wishing to be bound by any particular theory, it is believed that a medical professional may be able to use an impact map relating to a cranial injury in assessing a patient and/or recommending medical treatment. The present disclosure contemplates a method of assessing a patient that includes observing an impact map from a helmet that the patient was wearing during an incident.

### Guards/Protectors

The device may be an elbow guard or elbow protector. The device may be a knee guard or knee protector. The device may be a shin guard or shin protector. The device may be a glove, including a boxing glove or a mixed martial arts glove. The device may be a shoe. In some cases, the colorimetric mechanochromic sensor or precursor may be located in the sole of the shoe. In some cases, the colorimetric mechanochromic sensor or precursor may be located in the toc, forefoot, midfoot, or heel of the shoe.

In any of the immediately aforementioned devices, the colorimetric mechanochromic sensor or precursor may be located on at least one internal component of the device. Internal components of the device may include shell materials (i.e., external hard shells), foam materials, padding materials, straps, fitting or closure systems (i.e., loop and hook closures, buckles, buttons, clasp lockers, laces).

Without wishing to be bound by any particular theory, it is believed that a trainer might be able to adjust their training regimen based on information gleaned from impact maps acquired during training. For example, if a boxing glove shows consistent impact in a certain location, the trainer may suggest an altered punching technique.

### Article of Clothing

The present disclosure provides for an article of clothing including the colorimetric mechanochromic sensor and/or precursor, a colorimetric thermal sensor and/or precursor, and/or a colorimetric thermal-mechanochromic sensor and/or precursor.

An article of clothing is a covering designed to be worn on a person's body. Articles of clothing including the colorimetric sensors and precursors described immediately above include short-sleeve shirts, long-sleeve shirts, pants, hats, gloves, jackets, socks, vests, underwear, boots, skirts, shorts, insulate clothing, or tank tops. In a certain example, the articles of clothing may be worn as outerwear. In other certain examples, the articles of clothing may be worn as base layers (i.e., layers worn against the skin). In yet other certain examples, the articles of clothing may be worn as intermediate layers (i.e., layers worn over a base layer but not as outerwear).

In a certain example, the article of clothing may include body armor. In some cases, body armor includes protective clothing designed to absorb or deflect physical attacks. In certain examples, body armor includes shields held in the arm or hand, helmets, vests worn on the torso, or bomb suits (i.e., Explosive Ordnance Disposal (EOD) suit or blast suit).

In a certain example, the article of clothing may include protective equipment. In certain examples, protective equipment may include gloves, safety glasses and shoes, earplugs or muffs, hard hats, respirators, or coveralls, vests, and full body suits.

The core-shell vesicles may be applied to cloth or fibers used to construct articles of clothing. In some cases, the cloth may include cotton, wool, polyester, silk, rayon, nylon, linen, modal, elastane, leather, acetate, mohair, viscose, polyvinyl chloride, bamboo, hemp, polybenzimidazole fiber, ultra-high-molecular-weight polyethylene, polyphenylene sulfide, polylactic acid, polyhydroquinone-diimidazopyridinc, modacrylic, olefinic, acrylic, aromatic polyamide, poly(p-phenylene-2,6-benzobisoxazole), or any combination thereof.

In some cases, the core-shell vesicles may be applied to the article of clothing after the article of clothing is fully assembled, applied to the cloth or fabric or other materials used to construct the article of clothing, or applied to the fibers of the cloth or fabric or materials used to construct the article of clothing. In some cases, the core-shell vesicles are applied to the article of clothing in advance of activation with UV light (i.e., as the precursor) and in other embodiments the core-shell vesicles are applied to the article of clothing after activation with UV light (i.e., as the sensor).

In some cases, the article of clothing has vesicles arranged so the clothing functions as a blast sensor.

### Packaging Material

The present disclosure provides for packaging material including the colorimetric mechanochromic sensor and/or precursor, a colorimetric thermal sensor and/or precursor, and/or a colorimetric thermal-mechanochromic sensor and/or precursor.

In some cases, the packaging material having at least one internal or external component including the colorimetric thermal-mechanochromic sensor or precursor, colorimetric mechanochromic sensor or precursor, colorimetric thermal sensor or precursor.

In some cases, packaging material may include packing paper materials, foam sheets, bubble wrap, honeycomb packing paper, plastic film, package strapping, air pillows, shredded paper filler, aspen wool, plastic stretch wrap, foam pouches, packing peanuts, envelopes, padded envelopes, paper pallet, wooden pallet, metal pallet, plastic pallet, or the like.

In some cases, the core-shell vesicles may be applied to the packaging material after the packaging material is fully assembled or applied to the components of the packaging materials before they are constructed into the usable form of the packaging material. In some cases, the core-shell vesicles are applied to the packaging material in advance of activation with UV light (i.e., as the precursor) and in other embodiments the core-shell vesicles are applied to the packaging material after activation with UV light (i.e., as the sensor).

### Shipping Container/Box

The present disclosure provides for a shipping container or box including a colorimetric mechanochromic sensor and/or precursor, a colorimetric thermal sensor and/or precursor, and/or a colorimetric thermal-mechanochromic sensor and/or precursor.

A shipping container or box may include a large, standardized container designed and built for intermodal freight transport. In certain examples, a shipping container or box may include a metal shipping container or a plastic shipping container. In certain examples, a shipping container or box may include wood.

In some cases, the core-shell vesicles may be applied to the shipping container or box after the shipping container or box is fully assembled or applied to the components of the shipping container or box before they are constructed into the usable form of the shipping container or box. In some cases, the core-shell vesicles are applied to the shipping container or box in advance of activation with UV light (i.e., as the precursor) and in other embodiments the core-shell vesicles are applied to the shipping container or box after activation with UV light (i.e., as the sensor).

In one particular case, the shipping container can be a drone delivery package, such as a bag or a box that is carried by a drone from a supply facility to a user's location. The drone delivery bag or box can have exterior portions that are prominently labeled with the disclosed impact sensors. The bag or box can include prominent identifiers indicating that one color is associated with a delivery where high forces were avoided and another color is associated with the high forces occurring. A user can quickly identify whether their package was hit with a given force during delivery. An image of the package leaving the supply facility can be taken and compared with a post-delivery bag or box to show that the force occurred during transport.

### Adhesive Sheet

The present disclosure provides an adhesive sheet including the colorimetric mechanochromic sensor and/or precursor, a colorimetric thermal sensor and/or precursor, and/or a colorimetric thermal-mechanochromic sensor and/or precursor.

In some cases, adhesive sheets include a combination of a thin material, such as paper, and an adhesive that adheres the thin material to something else, such as a wall or floor. In some embodiments, the thin material may be paper, vinyl, or plastic.

In some embodiments, the core-shell vesicles may be applied to the adhesive sheet after the adhesive sheet is fully assembled or applied to the components of the adhesive sheet before they are constructed into the usable form of the adhesive sheet. In some embodiments the core-shell vesicles are applied to the adhesive sheet in advance of activation with UV light (i.e., as the precursor) and in other embodiments the core-shell vesicles are applied to the adhesive sheet after activation with UV light (i.e., as the sensor).

### Adhesive Tape

The present disclosure provides an adhesive tape including the colorimetric mechanochromic sensor or precursor, a colorimetric thermal sensor and a colorimetric thermal sensor precursor, and a colorimetric thermal-mechanochromic sensor and a colorimetric thermal-mechanochromic sensor precursor. In some embodiments the adhesive tape is arranged in a roll.

In some embodiments, adhesive tape includes a combination of a narrow strip of thin material, such as paper, and an adhesive that is typically used to hold or fasten something. In some embodiments, the narrow strip of thin material may be paper, vinyl, or plastic. In some embodiments the adhesive tape is packing tape, paper tape, masking tape, flooring tape, duct tape, electrical tape, painter's tape, double-sided tape, mounting tape, surgical tape, cloth tape, or gaffer tape.

In some embodiments, the core-shell vesicles may be applied to the adhesive tape after the adhesive tape is fully assembled or applied to the components of the adhesive tape before they are constructed into the usable form of the adhesive tape. In some embodiments the core-shell vesicles are applied to the tape in advance of activation with UV light (i.e., as the precursor) and in other embodiments the core-shell vesicles are applied to the adhesive tape after activation with UV light (i.e., as the sensor).

The tape assembly can in some cases be a layered tape assembly, where a top layer is visible initially and subsequent layers are only visible upon removal of layers atop the subsequent layers. Sequentially removing layers provides a series of impact sensing observations.

A set of tapes can be provided, where different tapes have different impact thresholds. The tapes can be labeled with some degree of watermarking, to identify which impact threshold is associated with the tape and/or which color relates to exceeding the impact threshold. A packaging center worker and/or automated robot could use tape having a certain impact threshold for certain taping jobs and tape having a different impact threshold for different taping jobs. For example, a low impact threshold tape could be used to hold parts together on the very innermost portion of a highly padded packaging, and a high impact threshold tape could be used to secure the outside of the box, where typically the impacts can be higher without negative consequence.

### Vehicle and Vehicular Component

The present disclosure provides for a vehicle or vehicular component including a colorimetric mechanochromic sensor and/or precursor, a colorimetric thermal sensor and/or precursor, and/or a colorimetric thermal-mechanochromic sensor and/or precursor.

The vehicle may be a wagon, a bicycle, a motor vehicle, a car a railed vehicle, a watercraft, an aircraft, a space craft, a passenger automobile, a truck, a bus, a shipping truck, an amphibious vehicle, a forklift, or the like.

In some embodiments, the vehicular component may include the front or rear bumpers, the body, the door skin, the hood, the fenders, the rear quarter panels, the roof, the frame, subframe components, the unibody, the engine and engine components, the transmission, the power steering, the differential, the brakes, the drive shaft, the clutch, suspension components, adaptive suspension components, heated or cooled seats, the dashboard, tires, wheels, wheel rims, fuel, oil, coolant, windows, a rudder, skids, wings, fins, hulls, sails, propeller, or any moving or non-moving components.

In some cases, the core-shell vesicles may be applied to the vehicle or vehicle component after it is fully assembled or applied to the components of the vehicle or vehicle component before they are constructed into the usable form of the vehicle or vehicle component. In some cases, the core-shell vesicles are applied to the vehicle or vehicle component in advance of activation with UV light (i.e., as the precursor) and in other embodiments the core-shell vesicles are applied to the vehicle or vehicle component after activation with UV light (i.e., as the sensor).

In certain cases, a vehicle's carbon-fiber part, such as a chassis, can be painted and subjected to aerodynamic testing, where forces exceeding an impact threshold can cause a visible change on the carbon-fiber part. Such forces can be compared to simulations for the purposes of aerodynamic tuning.

### Suitcase

The present disclosure provides a suitcase including a colorimetric mechanochromic sensor and/or precursor, a colorimetric thermal sensor and/or precursor, and/or a colorimetric thermal-mechanochromic sensor and/or precursor.

A suitcase is defined as a case with at least one handle and a hinged lid, used for carrying personal items. Included in this definition are non-rectangular cases, such as luggage. Suitcases may be wheeled or non-wheeled. The colorimetric sensor or precursor may be applied to interior or exterior components or surfaces of the suitcase.

The core-shell vesicles may be applied to the suitcase after it is fully assembled or applied to the components of the suitcase before they are constructed into the usable form of the suitcase. In some cases, the core-shell vesicles are applied to the suitcase in advance of activation with UV light (i.e., as the precursor) and in other embodiments the core-shell vesicles are applied to the suitcase after activation with UV light (i.e., as the sensor).

### Friction Sensor

The present disclosure provides a friction sensor including a colorimetric mechanochromic sensor and/or precursor, a colorimetric thermal sensor and/or precursor, and/or a colorimetric thermal-mechanochromic sensor and/or precursor.

### Paint

The present disclosure provides paint including a colorimetric mechanochromic sensor and/or precursor, a colorimetric thermal sensor and/or precursor, and/or a colorimetric thermal-mechanochromic sensor and/or precursor. The paint can be used to apply an impact and/or temperature sensing surface to a desired location. The paint can be used to coat surfaces which are observed for aerodynamic performance.

In some cases, the paint is tailored for use in a vacuum (e.g., for aerospace purposes).

### Ball

The present disclosure provides a ball including a colorimetric mechanochromic sensor and/or precursor, a colorimetric thermal sensor and/or precursor, and/or a colorimetric thermal-mechanochromic sensor and/or precursor. The ball can be inflatable. The ball can be solid.

The ball can be a sport ball, including but not limited to, a soccer ball or football, an American football, a baseball, a volleyball, a tennis ball, a squash ball, a racquet ball, a bowling ball, a billiard ball, a golf ball, or the like. In some cases, the ball is specifically tailored as a practice version of the ball (e.g., made out of less expensive material, designed to travel a shorter distance, etc.).

The term ball can be interpreted broadly to encompass any projectile that is used in a sporting context, such as a hockey puck or a badminton shuttlecock.

Without wishing to be bound by any particular theory, it is believed that a sports instructor of adequate skill (or a performer that is self-assessing) could deduce useful information from an impact pattern from a ball that is related to historical force. For example, a field goal kicker's coach could identify a sub-optimal contact point for kicking field goals based on an impact pattern on a football having the discloses sensors and can recommend an adjustment in technique based on their observations.

### Bat

The present disclosure provides a bat including a colorimetric mechanochromic sensor and/or precursor, a colorimetric thermal sensor and/or precursor, and/or a colorimetric thermal-mechanochromic sensor and/or precursor. The bat can be a sporting bat, such as a baseball bat, a cricket bat, or the like.

Without wishing to be bound by any particular theory, it is believed that a sports instructor of adequate skill (or a performer that is self-assessing) could deduce useful information from an impact pattern from a bat that is related to historical force. For example, a baseball player or their hitting coach could immediately visually observe contact locations on the baseball bat and make swing adjustments in response.

### Impact Dampening Foam

The present disclosure provides an impact dampening foam including a colorimetric mechanochromic sensor and/or precursor, a colorimetric thermal sensor and/or precursor, and/or a colorimetric thermal-mechanochromic sensor and/or precursor.

One significant advantage of the present disclosure is the ability for the sensors described herein to be distributed throughout a volume of impact dampening foam, thereby reporting on impacts throughout the volume rather than just on surfaces and at interfaces.

One particular impact dampening foam application involves the use of foam to investigate a runner's gait. A three-dimensional impact-reporting foam can be used as the padding in footwear to provide three-dimensional impact reporting.

Another particular impact dampening foam is a conformal foam that can be applied to sensitive materials with fine details (e.g., Faberge eggs), such that the foam conforms to the article without applying significant force. The foam cures to a hardened form that is resistant to forces up to a certain level. When the foam is embedded with the sensors described herein, the colorimetric reporting on impact is present throughout the foam, so a visual inspection of the protective foam can provide some information regarding the condition of the contents prior to opening.

In some cases, the foam can be sprayable.

### Insurance Evaluation Tool

The present disclosure provides an insurance evaluation tool including a colorimetric mechanochromic sensor and/or precursor, a colorimetric thermal sensor and/or precursor, and/or a colorimetric thermal-mechanochromic sensor and/or precursor. An insurance company can deploy tools into the field which provide impact maps, as described herein, which can be interpreted for the purpose of providing an insurance assessment.

Such an evaluation tool may be particularly useful in instances where items are rented or borrowed, such as renting a car or borrowing protective equipment while ice skating.

### Hidden Sensor

The present disclosure provides an interior sensing element including a colorimetric mechanochromic sensor and/or precursor, a colorimetric thermal sensor and/or precursor, and/or a colorimetric thermal-mechanochromic sensor and/or precursor. The interior sensing element is located in a device that has a portion capable of being hidden from view. Sensors can be located inside the portion hidden from view. Upon opening the device to reveal the interior sensing element, colorimetric analysis can be performed to assess the extent of impact prior to opening the portion of the device capable of being hidden from view.

### Ballistic Gel

The present disclosure provides a ballistic gel including a colorimetric mechanochromic sensor and/or precursor, a colorimetric thermal sensor and/or precursor, and/or a colorimetric thermal-mechanochromic sensor and/or precursor. The sensor and/or precursor can be distributed throughout the ballistic gel or can be concentrated at certain locations (e.g., vital organs in a human model).

In typical usage, visual assessment of the ballistic gel is performed to assess impacts. With the inclusion of the disclosed sensors and/or precursors, the impact can be visualized at distinct locations within the post-impact ballistic gel, thereby providing enhanced information.

In some cases, the ballistic gel is configured as a crash test dummy. In some cases, a crash test dummy can be prepared without the use of ballistic gel and such crash test dummies can also include the sensors/vesicles described herein.

### Mechanical Gear

The present disclosure provides a mechanical gear including a colorimetric mechanochromic sensor and/or precursor, a colorimetric thermal sensor and/or precursor, and/or a colorimetric thermal-mechanochromic sensor and/or precursor. The gear can have the disclosed sensors and/or precursors embedded throughout or can have a coating including the disclosed sensors and/or precursors.

In typical usage, gears tend to break before they are replaced. With gears including the disclosed sensors and/or precursors, the color of the gears can be monitored for changes that reflect undesirable forces on the gear. It may be possible to detect forces that would cause complete mechanical failure prior to the failure itself.

### Threaded Article

The present disclosure provides a threaded article including a colorimetric mechanochromic sensor and/or precursor, a colorimetric thermal sensor and/or precursor, and/or a colorimetric thermal-mechanochromic sensor and/or precursor. The threaded article can be a screw, a bolt, a nut, a lid, a jar, or the like. The sensors and/or precursors disclosed herein can be embedded within the threaded part or applied as a coating to the threaded part of the threaded article, thereby providing a visual indicator of the force experienced by the threading.

### Gaskets and Seals

The present disclosure provides gasket or a seal including a colorimetric mechanochromic sensor and/or precursor, a colorimetric thermal sensor and/or precursor, and/or a colorimetric thermal-mechanochromic sensor and/or precursor. The gasket or seal can have the sensor or precursor applied to one or more surfaces. The gasket or seal can have the sensor or precursor distributed throughout the material of the gasket or seal.

### Rope and Related Hardware

The present disclosure provides a rope, cord, and/or string including a colorimetric mechanochromic sensor and/or precursor, a colorimetric thermal sensor and/or precursor, and/or a colorimetric thermal-mechanochromic sensor and/or precursor. While appreciating that there may be distinctions in particular form, for the case of description, most of the features relating to this aspect of the present disclosure will be described as applicable to ropes, but those features are also applicable to cords, strings, and other related materials, unless the context clearly dictates otherwise.

Certain fields rely on the strength of ropes, cords, and/or strings for safety, including but not limited to, climbing (e.g., rock climbing) and boating.

Unrelated to the specific context, the rope itself can include the disclosed sensors and/or precursors. Monitoring the color of the deployed sensors can provide information regarding the forces that the rope is experiencing, thereby providing information regarding potential wear or damage.

In the climbing context, the ropes are generally used with climbing hardware, such as tie-offs, carabiner clips, belays, cams, and the like. The disclosed precursors and/or sensors can be distributed throughout the material that composes the hardware or can be applied as a surface coating onto the hardware.

In the boating context, the ropes are generally used to restrain movement of a vessel, often in a docking environment. In general, the disclosed precursors and/or sensors can be used with boating hardware that interfaces with boating ropes. Examples of boating hardware include, but are not limited to, cleats, dock bumpers, and the like. The disclosed precursors and/or sensors can be distributed throughout the material that composes the hardware or can be applied as a surface coating onto the hardware.

Traditionally, hardware is visually assessed and replaced when it appears to be worn beyond a certain point. Use of the disclosed sensors can provide enhanced information regarding the forces that the hardware is experiencing, which may facilitate predictive maintenance to hardware associated with ropes.

### Targets

The present disclosure provides a target including a colorimetric mechanochromic sensor and/or precursor, a colorimetric thermal sensor and/or precursor, and/or a colorimetric thermal-mechanochromic sensor and/or precursor.

In some cases, the target requires a minimum force to indicate a successful strike. This can be achieved with a single type of sensor having one force threshold.

In some cases, the target requires a force falling within a specific window to indicate a successful strike. This can be achieved with two types of sensors, each having different colorimetric response and different force thresholds. When both force thresholds are exceeded, a combined color is presented. When neither force threshold is exceeded, a single color is presented. When neither force threshold is exceeded, a default color is presented. A game can be constructed where the single color represents the winning condition.

### Particle Board

The present disclosure provides a particle board including a colorimetric mechanochromic sensor and/or precursor, a colorimetric thermal sensor and/or precursor, and/or a colorimetric thermal-mechanochromic sensor and/or precursor. In general, particle board is composed of a filler material (e.g., wood chips and sawdust) and a binder. In some cases, particle board can include the sensors and/or precursors described herein embedded within the binder of the particle board. In some cases, particle board can include a surface coating with the sensors and/or precursors described herein.

Because of the composite nature of particle board, observing fractures and physical flaws may be more challenging than in other materials. Use of the sensors described herein can allow visual observation of forces and/or temperatures within the particle board material itself.

### Robot

The present disclosure provides a robot including a colorimetric mechanochromic sensor and/or precursor, a colorimetric thermal sensor and/or precursor, and/or a colorimetric thermal-mechanochromic sensor and/or precursor. The present disclosure also provides a robot operating in an environment with other articles including a colorimetric mechanochromic sensor and/or precursor, a colorimetric thermal sensor and/or precursor, and/or a colorimetric thermal-mechanochromic sensor and/or precursor. The robot can be integrated with vision capability and machine learning capacity to observe colorimetric changes associated with impacts emerging from the robot itself. At a very general level, the sensors described herein can help automated systems visually identify the force of impacts without requiring complex force sensors.

### Semiconductor Processing

The present disclosure provides a semiconductor processing coating including a colorimetric mechanochromic sensor and/or precursor, a colorimetric thermal sensor and/or precursor, and/or a colorimetric thermal-mechanochromic sensor and/or precursor. The sensors and precursors described herein may be particularly useful in semiconductor manufacturing (or other electronic manufacturing). They are compatible with many of the chemical environments utilized in semiconductor manufacturing, including aqueous environments. The sensors can report on impact forces without requiring direct inspection of manufactured parts themselves.

### Cosmetics

The present disclosure provides a cosmetic including a colorimetric mechanochromic sensor and/or precursor, a colorimetric thermal sensor and/or precursor, and/or a colorimetric thermal-mechanochromic sensor and/or precursor. The cosmetic could be utilized in a variety of fields, including the arts (e.g., make up for a body slapping musical performance that leaves behind hand prints where the musical “notes” were played), sports (e.g., a map of impacts on a pugilist's face or body), and the like.

### Glass Impact Sensor

The present disclosure provides a glass impact sensor comprising a colorimetric mechanochromic sensor and/or precursor, a colorimetric thermal sensor and/or precursor, and/or a colorimetric thermal-mechanochromic sensor and/or precursor. The sensors can be coated onto a surface of the glass or can be embedded within layers of a glass structure.

### A System for Using Colorimetric Mechanochromic Sensors

The present disclosure provides a system for recording and measuring mechanical impact and/or temperature, the system including a camera, a processor, and a memory. The system described herein is usable with the sensors or methods described elsewhere in this disclosure.

In some embodiments, a camera may include photodiodes. It should be recognized that any opto-electronic conversion device including but not limited to photo detectors, photodiodes, line-scan and two-dimensional cameras, and photodiode arrays can be used to perform this detection function.

In some embodiments, a processor may include any suitable hardware processor or combination of processors, such as a central processing unit, a graphics processing unit, etc.

In some embodiments a memory may include can include any suitable storage device or devices that can be used to store instructions, values, etc., that can be used, for example, by processor to present content using display, to communicate with server via communications system(s), etc. Memory can include any suitable volatile memory, non-volatile memory, storage, or any suitable combination thereof. For example, memory can include RAM, ROM, EEPROM, one or more flash drives, one or more hard disks, one or more solid state drives, one or more optical drives, etc. In some embodiments, memory can have encoded thereon a computer program for controlling operation of computing device. In such embodiments, processor can execute at least a portion of the computer program to present content (e.g., images, user interfaces, graphics, tables, etc.), receive content from server, transmit information to server, etc.

In one embodiment, the processor in communication with the camera, and a memory in communication with the processor having stored thereon a set of instructions which, when executed by the processor, causes the processor to: conduct an evaluation of the colorimetric thermal and/or mechanochromic sensor, including: receiving, from the camera, a measure of temperature and/or mechanical impact, generating a report of the temperature and/or mechanical impact.

In another embodiment, the processor in communication with the camera, and a memory in communication with the processor having stored thereon a set of instructions which, when executed by the processor, causes the processor to: conduct a first evaluation of the colorimetric thermal and/or mechanochromic sensor, including: receiving, from the camera, a first measure of temperature and/or mechanical impact, generating a first report of the temperature and/or mechanical impact; conduct a second evaluation of the colorimetric sensor, including: receiving, from the camera, a temperature and/or mechanical impact, generating a second report of the temperature and/or mechanical impact; and compare the first evaluation and the second evaluation.

### Methods of Making

The present disclosure provides a method of making a plurality of core-shell vesicles having mechanochromic and/or temperature sensing properties. The method includes mechanically agitating a water-based solution of silk fibroin and acetylene (e.g., PCDA) at an elevated temperature to produce a composition comprising a plurality of core-shell vesicles.

The mechanically agitation can be performed by sonication, vigorous stirring, or with a blender. In some cases, vigorous stirring may be preferred. In some cases, sonication may be preferred.

The method can further include centrifuging the composition comprising the plurality of core-shell vesicles to at least partially isolate one or more individual components, including but not limited to aggregates of vesicles, unintended waste products, and the like, from the composition.

The method may further includes size-selecting the plurality of core-shell vesicles to produce a subset of core-shell vesicles having predetermined size properties. In some embodiments, the size-selecting the plurality of core-shell vesicles to produce a subset of core-shell vesicles may be accomplished by cyclonic mass separation, fluidic size separators, gradient centrifugation, microfluidic sorting, oscillating shape sorting, or light scattering sorting (i.e., flow cytometry).

In another aspect, the method may have a mass yield of producing the plurality of core-shell vesicles from the silk fibroin and the polyacetylene of at least 5%, at least 10%, at least 15%, at least 25%, at least 30%, at least 35%, at least 40%, at least 45%, at least 50%, at least 55%, at least 65%, or at least 70%, at least 80%, at least at least 85%, at least 90%, at least 95%, or greater.

### Methods of Activating a Precursor

The present disclosure provides a method of activating a colorimetric mechanochromic and/or temperature sensor precursor to produce a colorimetric mechanochromic and/or temperature sensor, the method comprising exposing the colorimetric mechanochromic and/or temperature sensor precursor to ultraviolet light at a predetermined exposure intensity for a predetermined length of time.

In one embodiment, the colorimetric mechanochromic and/or temperature sensor precursor may be activated by exposure to ultraviolet light between 1-600 seconds, between 1-500 seconds, between 1-400 seconds, between 1-300 seconds, between 1-200 seconds, between 1-100 seconds, between 1-60 seconds, or between 1-30 seconds.

In another embodiment, the colorimetric mechanochromic sensor precursor may be exposed to an ultraviolet dose of no less than 10-200 mJ/cm², no less than 10-300 mJ/cm² no less than 10-150 mJ/cm², no less than 10-100 mJ/cm², no less than 10-50 mJ/cm², no less than 10-25 mJ/cm², or no less than 10-15 mJ/cm².

In another embodiment, the ultraviolet light used to convert the precursor to the sensor has a wavelength between 10 nanometers to 400 nanometers. In another embodiment, the wavelength may be 254 nanometers.

### Methods of Using/Analyzing

A method of using a colorimetric mechanochromic sensor is disclosed. The method includes: striking the colorimetric mechanochromic sensor, thereby initiating a change in the first characteristic colorimetric property.

The present disclosure provides for a method of analyzing an image to produce a mechanochromic impact and/or temperature map for an article including the colorimetric mechanochromic impact and/or colorimetric temperature sensor described elsewhere herein. The method including: a) assessing a pre-impact and/or pre-temperature image for the presence of the first characteristic colorimetric property, b) assessing a post-impact and/post-temperature image for the presence of the first characteristic colorimetric property, c) generating the mechanochromic impact and/or temperature map from a difference in the first characteristic colorimetric property between a pre-impact and/or pre-temperature image and a post-impact and/or post-temperature image.

### EXAMPLES

### Example 1

The majority of commercially available mechanical sensors are based on electronic systems which need additional circuitry assembly and displays, are bulky and have limited conformation abilities, and often need users' training for a correct interpretation of the readout. On the other hand, colorimetric mechanical sensors exhibit a visible optical response upon application of mechanical force. Therefore, they offer various advantages such as being cost-effective, not requiring a power source and allowing easy detection of stimuli even by the naked eye, thus finding essential applications as impact and damage indicators in sports-related devices, household products, smart packaging, and civil engineering. Such sensors can be reversible, thus allowing to be used multiple times but with no recorded history of the impacts, or irreversible, thus offering a single use that tracks the history of the impact a material has been subjected to. The former sensors are often based on photonic materials with reversible structural changes, while the latter rely on chemical strategies to imprint a colorimetric mark of mechanical force. As such, mechanoresponsive chemicals often benefit from a protective layer to maximize their selectivity.

One strategy to fabricate such sensors consists in combining mechanochromic molecules with a second building block that does not alter the colorimetric response of the former while also providing chemical/mechanical encapsulation.

Silk fibroin (SF) derived from the cocoons of Bombyx mori is a structural protein that is widely used in material science due to its mechanical, chemical, and optical properties. Specifically, its tunable conformation allowed the development of functional materials^{[9]} suitable for optics, electronics, and sensing applications, while its biocompatibility and ability to stabilize labile compounds led to an extensive use in the biomedical field. SF's primary sequence consists of alternating hydrophobic and hydrophilic regions that confer it the ability to self-assemble into clear vesicular structures within aqueous solutions.

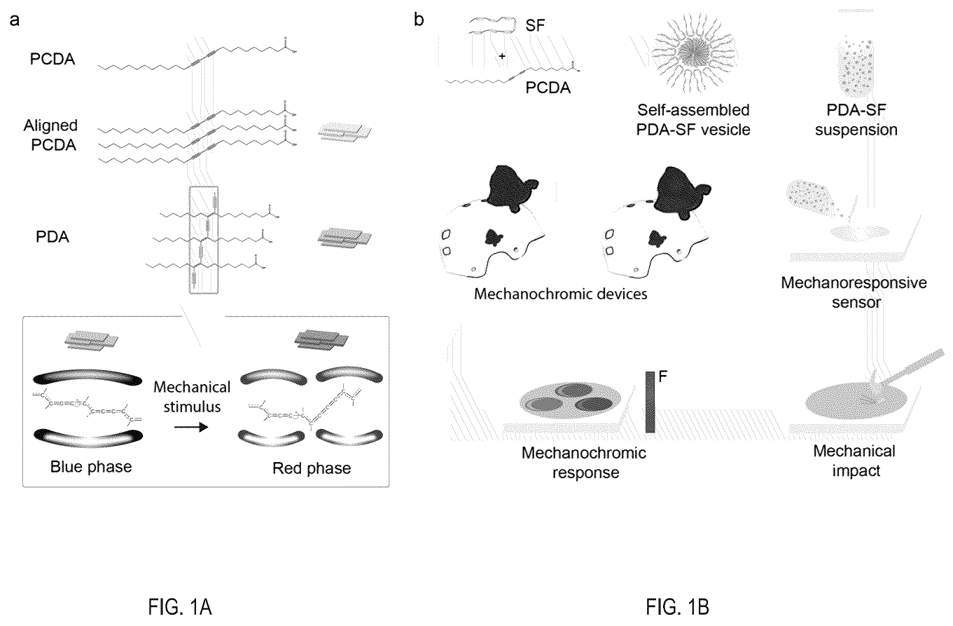

Polydiacetylenes (PDAs) polymers have been extensively studied for sensing applications due to their versatile structural and spectral features. More specifically, they undergo a blue-to-red colorimetric reflective transition as a response to several external stimuli including solvents, temperature, mechanical stress, light, pH, metal ions, anions, surfactants, microorganisms, and biomolecules, thus offering a number of opportunities for developing bio- and chemo-sensors. Usually, PDAs show an absorption peak at ˜λ_{blue phase}=640 nm, which appears visually as an intense blue color that, upon interaction with external stimuli, shifts hypsochromically to ˜λ_{red phase}=540 nm, which appears as a red color easily detectable by the naked eye (FIG. 1A). Mechanochromism in polydiacetylene polymers occurs when a specific amount of mechanical energy is delivered to the PDA backbone causing the disruption of the π-orbitals and the consequent colorimetric transition. Although mechanochromism has been studied for polydiacetylenes, there are few reports for mechanical sensing applications and none of them offers the possibility to quantify the mechanical energy that caused the color transition. PDA-based sensors are commonly synthesized as self-assembled bilayer liposomes by the combination of 10-12 pentacosadyenoic acid (PCDA) and the phospholipid 1,2-dimyristoyl-sn-glycero-3-phosphocholine (DMPC). Their preparation requires first a self-alignment of the diacetylene monomer that polymerizes through the 1,4-addition by UV exposure (2=254 nm), which generates the polymeric backbone with alternating C═C and C≡C bonds (ene-yne).

Here, the ability of SF to assemble in micellar structures was exploited to fabricate cost-effective self-assembled micrometer-sized core-shell vesicles with a mechanochromic core of PDA and a protective shell of SF that can be used as colorimetric impact sensors (FIG. 1B). The vesicles turn mechanosensitive after activation by exposure to UV light which causes the internal diacetylene polymerization with the consequent formation of a blue color; the PDA-SF vesicles can then undergo a colorimetric transition visible to the naked eye when an impact force in the range F=220-440 N is delivered. To the best of our knowledge, this range of detection is the highest and the widest reported so far for colorimetric mechanochromic sensors, with the possibility to be extended to F=110-770 N using fluorescence analysis. The mechanochromic response of the PDA-SF vesicles was assessed onto paper substrates and compared to the response of PDA-DMPC vesicles. Finally, a series of demonstrator devices was prepared to show the versatility of the PDA-SF vesicles to be cast onto different substrates and their applicability for various devices.

Materials: 10-12 pentacosadyenoic acid, sodium carbonate, lithium bromide and chloroform were purchased from Sigma Aldrich and were used without any further purification. 1,2-dimyristoyl-sn-glycero-3-phosphorylcholine (DMPC) was purchased from AVANTI Polar Lipids and was used without any further purification. Bombyx mori cocoons were purchased from Tajima Shoji (Japan).

Silk fibroin solution (see, D. N. Rockwood, R. C. Preda, T. Yücel, X. Wang, M. L. Lovett, D. L. Kaplan, Nat. Protoc. 2011, 6, 1612, which is incorporated herein by reference for all purposes): Bombyx mori cocoons were degummed by cutting and boiling 10 g of cocoons in 4 L of 0.8 M Na₂CO₃ solution for 30 min to remove sericin. The washed and dried fibers were then dissolved in 9.3 M lithium bromide solution for 3 h at 60° C. The obtained silk solution was dialyzed against Milli-Q water using a 3.5 MWCO nitrocellulose dialysis tubing for 3 days to remove residual lithium bromide. The silk solution was then filtered with nitrocellulose filter (70 μm, Falcon® cell strainers), centrifuged (Beckman Coulter Allegra X-14 Centrifuge, rotor FX6100) at 10200 rpm for 20 min at 4° C., and then filtered again to remove debris. The silk solution concentration was determined gravimetrically. Reconstituted silk fibroin solution was concentrated, as needed, up to 10% by pouring it into a 3.5 MWCO dialysis tubing and placing it into a drying chamber. Finally, the solution was stored at 4° C. until further use.

Synthesis of PDA-based vesicles: The general protocol (see, J. T. Wen, J. M. Roper, H. Tsutsui, Ind. Eng. Chem. Res. 2018, 57, 9037, which is incorporated herein in its entirety for all purposes) for the preparation of PDA liposomes involves first the dissolution of the DA monomers, along with DMPC, in chloroform to create an even distribution of monomers. Chloroform is then evaporated by N₂ stream leaving a white film behind. Since SF is completely insoluble in chloroform, for the synthesis of the PDA-SF vesicles, the silk solution was added on a dried DA film after chloroform evaporation. Briefly, 10 mg of PCDA were dissolved in 15 mL of chloroform. The solvent was then evaporated and either 6.6 mg of DMPC or 100 mg of silk were added for the synthesis of either PCDA-DMPC or PCDA-SF, respectively.

The resulting mixture was resuspended in MilliQ water and dispersed by sonication at above 80° C., the phase transition temperature I of PCDA^{[48]}. The resulting solution was then filtered through a nylon membrane (40 μm, Falcon® cell strainers) to remove any aggregates. The solutions were tip-sonicated (Misonix Sonicator model XL-2000) at power 240 W for 15 minutes. To promote liposomes stability and the alignment of the DA backbone, the colloidal suspension was stored at 4° C. overnight. The solution was then centrifuged using a Beckman Coulter Allegra X-14 Centrifuge equipped with a swinging bucket rotor (SX4750A) at 1000 rpm for 10 minutes in order to remove the bigger vesicles and aggregates; the supernatant was then collected and further centrifuged for three times at 4300 rpm for 3 h to concentrate the vesicles. After this, the pellet was collected and used as starting batch for the fabrication of the mechanochromic sensors. The concentration of the PDA-SF solution was measured gravimetrically with C_{PDA-SF}=7 mg mL⁻¹ and C_{PDA-DMPC}=0.5 mg mL⁻¹.

We also performed a scale-up of the synthesis using 2.5 g of silk and 250 mg of PCDA in a 250 mL batch affording roughly 2 g (72% yield) of mechanical sensors, thus offering a possible transfer of PDA materials from laboratory scale (production in the range of tens of milliliters) use to industrial application. To best of our knowledge, this works reports the highest synthesis scale for PDA-based sensors.

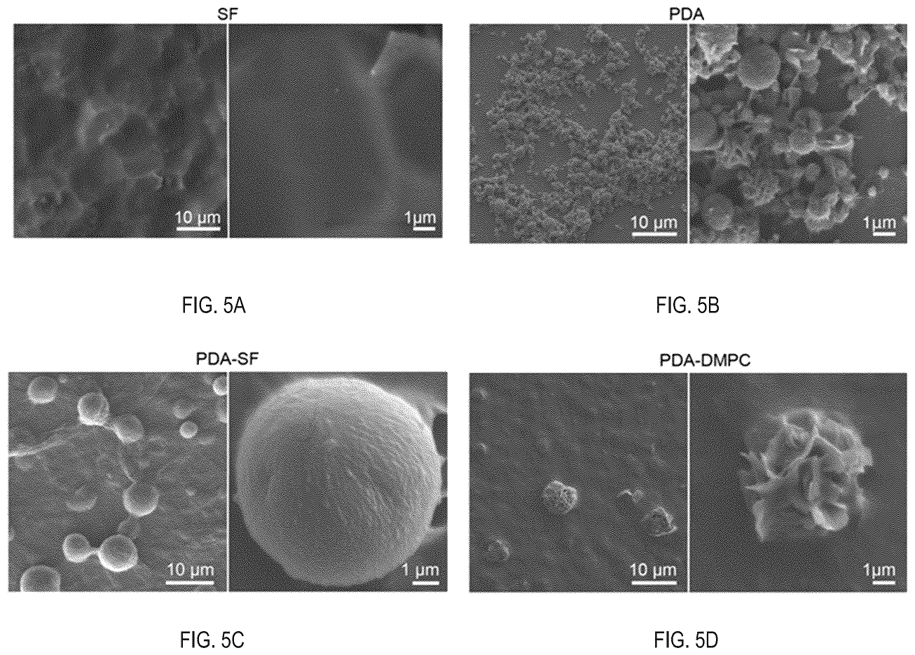

FTIR: Fourier-Transform Infrared Spectroscopy (FTIR) spectra of SF-PDA vesicles were acquired using a Bruker Invenio S Diamond ATR with a resolution of 1 cm⁻¹ within a scan range between 400-400 cm⁻¹ and with the accumulation of 64 scans. FTIR spectra of SF was obtained from dried films of 5% solution of SF since SF without PCDA do not form vesicular structures (FIGS. 5A-D) or precipitates during centrifugation.

UV-Vis Spectroscopy: UV-Vis spectra of 1 mg mL⁻¹ PDA-SF or PDA-DMPC vesicle solutions were acquired using a Biotek synergy HT plate reader. The PDA sensors were activated by exposing them to the light of a VL-215.G 60 W UV lamp for 2 minutes. The energy delivered by the lamp is 2.5 mWcm⁻² measured with S302C—Power Sensor Head, Surface Absorbe (Thorlabs) and the relative UV dose (mJ cm⁻²) can be quantified by multiplying the power (mW) by the exposure time(s).

Zeta potential: Zeta potential measurements were conducted, obtaining a value of −47.7 mV for a solution of 1 mg/mL of small-sized vesicles in distilled water. Such a negative value suggests the formation of a stable colloidal solution. With various optimizations in sensor purifications, stable colloidal solutions should be achievable at higher concentrations (up to 10 mg/mL) with no precipitation or aggregation for up to 20 days at 8° C.

Paper based sensor preparation and drop dart testing: Paper based sensors were obtained by laser cutting (Trotec Speedy 300 lasercutter) 120 lb cardstock paper (Desktop Publishing Supplies) in 1 inch squares and by drop casting 50 μL of 2 mg mL⁻¹ either PDA-SF or PDA-DMPC suspension on them. The sensors were dried at room temperature and activated by UV irradiation for 2 min (UVP XX-Series UV Bench Lamp, 115V).

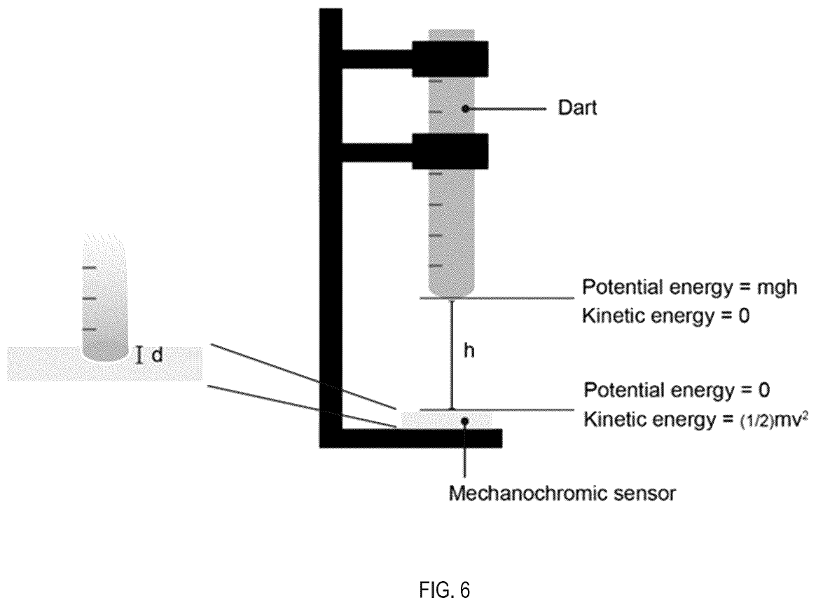

The sensors' mechanical activation was performed by using a custom-made drop tower mechanism specifically designed for impact testing (FIG. 6). A 150×25 mm steel dart (model, brand) with a diameter of 1 cm was positioned on a pullable pin set at an adjustable height between 1 and 6 cm above the sensor. When the pin is pulled, the dart falls and hits the material, thus activating the colorimetric transition in the region directly hit by the dart. For the calculation of the impact energy, the potential energy from the falling object (the dart) is assumed to convert to kinetic energy without dissipation so that the 450.0 g dart falling from 1 cm height causes 110 N of mechanical impact, considering a deformation of d=0.3 mm (paper thickness); each increase of falling height of 1 cm induces an increase in the delivered force of additional 110 N (Table 1). Velocity, energy, and impact force from different falling heights are summarized in Table 1.

TABLE 1

| | | | Impact |
|---|---|---|---|
| Falling | Falling | | force [N] |
| height | velocity | Kinetic | deformation |
| [cm] | [ms⁻¹] | energy | 1 mm |
| 2 | 0.62 | 0.088 | 88 |
| 3 | 0.76 | 0.13 | 132 |
| 4 | 0.88 | 0.176 | 176 |
| 5 | 0.99 | 0.22 | 220 |

Mechanochromic sticker: To fabricate the mechanochromic sticker, a suspension of PDA-SF vesicles was cast on a vinyl sheet and dried at room temperature so to form a film with vesicle density of 2 mg cm⁻². The mechanochromic layer was activated through UV radiation at λ=254 nm for 30 seconds. The mechanochromic sticker is then formed by recovering the activated layer of vesicles using double-sided tape and by cutting it in the desired shape.

Mechanochromic polystyrene sheet: The polystyrene hexagonal substrates (side 1=50 mm) were obtained from weighting boats (Fisherbrand® Polystyrene Antistatic Weighing Dishes) and exposed to UV light at λ=254 nm for 3 h to increase surface's wettability. Then, the PDA-SF suspension was cast on top forming a film with density of 2 mg cm⁻² which was then activated with UV light for further 30 s to polymerize the vesicles.

Optical microscopy: A customized Olympus Inverted IX71 microscope equipped with a DSLR (digital single-lens reflex) camera (Canon Rebel T1i) and a halogen lamp (Olympus, U-LH100L-3) as light source was used to perform optical microscopy. Bright-field reflection images were collected using a 4× (Olympus, UplanFL N, numerical aperture 0.13) objective. To quantify the reflectance of the paper-based sensors, the microscope was coupled to a multispectral camera (CRI, Nuance EX). The paper-based sensors were observed in bright-field reflection, and the spectral cubes were acquired in the spectral range 2=450-750 nm with a step size of 3 nm. The software Nuance 3.0.2 was used to acquire and unmix the spectral cubes in individual spectral components. When the activation of the PDA-SF sensors induced deformation in the paper substrates, multiple micrographs were acquired at different focal points and combined using the focus-stacking algorithm using the software ImageJ.

Colorimetric analysis: For the UV activation, the colorimetric analysis of the paper-based sensors was performed evaluating the ratio I_{red}/I_{blue} with I_{red} being the reflectance intensity at 2=570 nm and I_{blue} the reflectance intensity at 22=651 nm. The spectral positions for A and 22 were extrapolated from the absorbance spectra of the liquid SF-PDA solution: λ₁=570 nm corresponds to the red phase of the PCDA, while λ₂=651 nm to the blue phase. The reflectance spectra were acquired using the multispectral camera for three different replicates of the sensors; the measurements were performed in triplicates and reported as mean values (Mean)±standard deviation (SD).

Electron microscopy: The PDA-DMPC and PDA-SF vesicles solutions were cast on thin cover slip, dried at room temperature and mounted on aluminum stubs by using conductive carbon tape. To ensure electrical conductivity, the stubs were sputtered with ˜10 nm of gold using an Emitech SC7620 sputter coater. The prepared specimens were imaged in top view using a Zeiss EVO MA10 SEM with a secondary electron detector at 10 kV and 7 to 9 mm as the working distance. The SEM images were analyzed with the software ImageJ to determine the diameter of the PDA-SF vesicles: the values were reported as mean values±standard deviation (SD) for N=189 vesicles. To image the internal morphology of the PDA-SF vesicles the following protocol (see, R. M. Parker, B. Frka-petesic, G. Guidetti, G. Kamita, G. Consani, C. Abell, S. Vignolini, ACS Nano 2016, 10, 8443, which is incorporated herein in its entirety for all purposes) was used: the PDA-SF ink was cast on a glass coverslip previously covered with a layer of nail polish (nitrocellulose in butyl acetate). A second layer of polish was applied to ensure complete embedding of the particles. The particles were then placed in an Argon atmosphere, cooled in liquid nitrogen, and mechanically cryo-fractured. The fragments containing the particles were then mounted on aluminum stubs using conductive carbon tape and sputtered with ˜10 nm of gold.

Macroscopic photographs: Digital images of the paper-based sensors and of the prototypes were taken with a DSLR (digital single-lens reflex) camera (Canon Rebel EOS-SL1). The RAW image files were adjusted for exposure and contrast.

### Results and Discussion

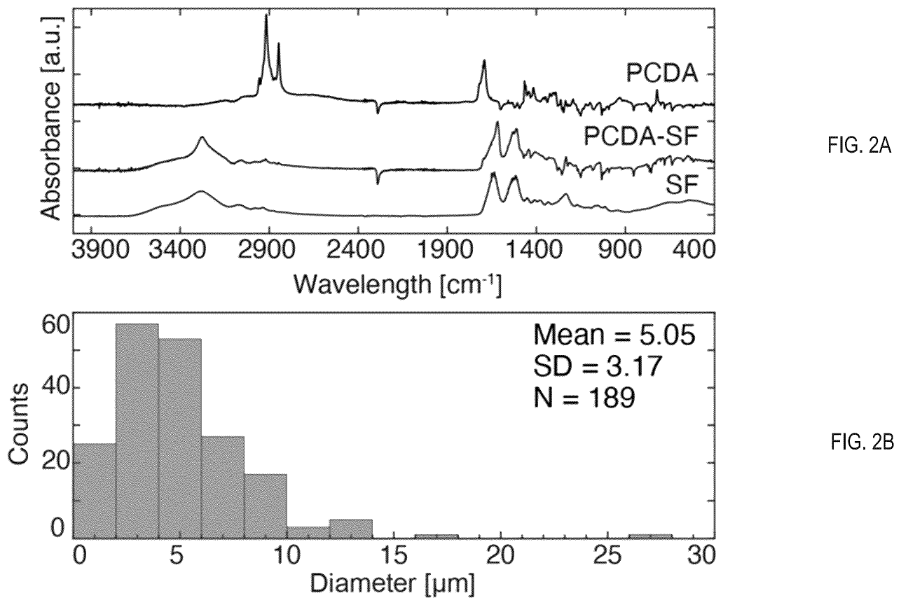

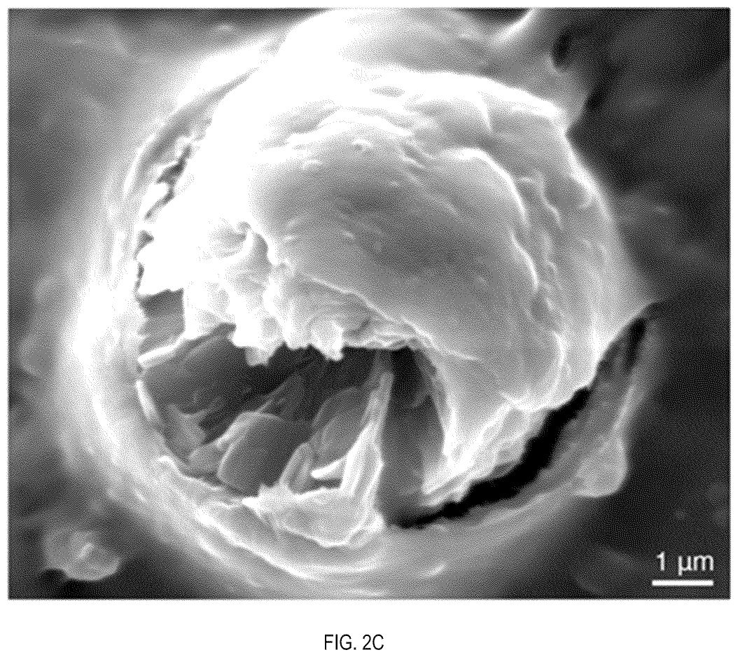

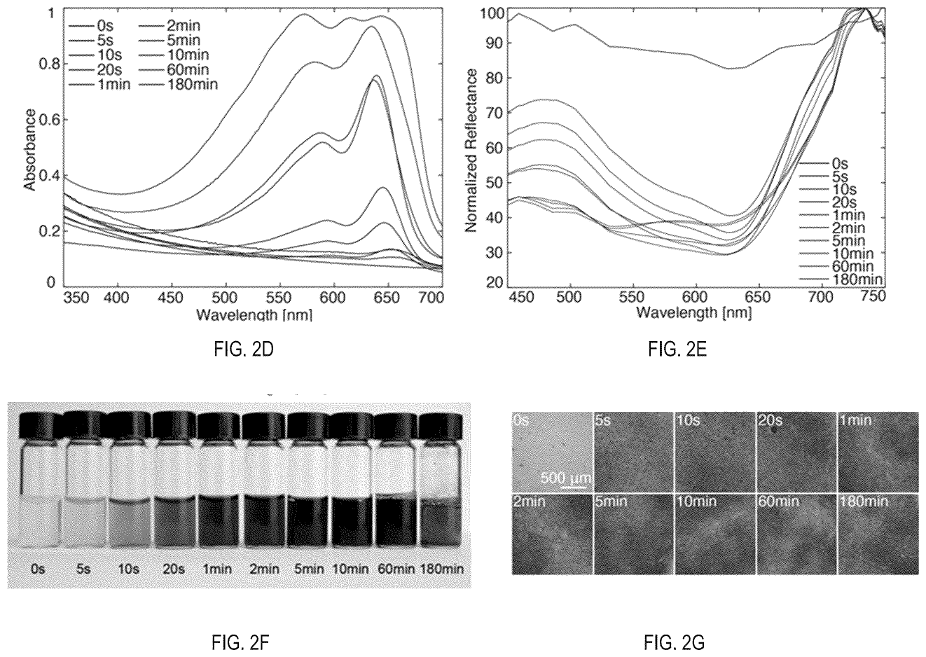

Mechanochromic core-shell vesicles were synthesized through a scalable self-assembly process involving tip sonication of a water-based solution of SF and PCDA, followed by centrifugation. This process leads to the formation of vesicles made of PDA and SF as confirmed by the simultaneous presence of the characteristic Fourier-Transform Infrared Spectroscopy (FTIR) peaks of both PCDA and SF (FIG. 2A): the three main peaks of PCDA are visible at 2919 cm⁻¹ (ν_{a, CH2}), 2848 cm⁻¹ (ν_{s, CH}), and 1694 cm⁻¹ (ν, _{C═O}), while the three main bands of SF^{[38] at} 1700-1600 cm 1 (ν_{C═O} amide I), 1600-1500 cm 1 (ν_{s, C—N} amide II) and 1330-1230 cm 1 (δ_{s, C—N} amide III).

The fabricated vesicles have a mean diameter of (5.1±3.2) μm (mean±SD, N=189, FIG. 2B); morphologically, the crystalline PDA sheets assemble in a dense core, while SF forms a continuous layer around them forming the core-shell structure as confirmed by scanning electron microscopy (SEM) (FIG. 2C). The relative arrangement of PDA and SF during self-assembly is driven by SF's chemical properties that promote the formation of a hydrophobic pocket allowing a higher solubility and packing of the hydrophobic PCDA within the same, especially compared to the traditional fabrication method involving DMPC instead of SF. For comparison, PDA-DMPC vesicles of a similar size were fabricated following the same protocol (see above), but with no evidence of core-shell assembly and with heterogeneous surface morphology with exposed PDA sheets (FIGS. 5A-D). The PDA-SF suspension shows higher stability (η_{PDA-SF}=−47.70 mV) compared to the PDA-DMPC suspension (η_{PDA-DMPC}=−21.88 mV) which was observed to form macroscopic aggregates few days after synthesis.

The UV-activated polymerization of PCDA-SF into PDA-SF is a necessary step for the vesicles to display a blue coloration (blue phase); despite this, a prolonged exposure to the UV is known to induce the blue-to-red transition (red phase) in PDAs, thus nullifying their use for colorimetric sensing. Thus, the effect of UV exposure time on the polymerization process of PDA-SF was investigated in liquid (FIGS. 2D and 2F) and solid (FIGS. 2E and 2G) formats to determine the ideal exposure time for the blue phase of the PDA-SF to be detected by the naked eye and provide enough contrast with respect to a white background.

In solution, exposure to UV light at λ=254 nm for t≥5 s activates the blue phase of PCDA, as confirmed by the characteristic absorbance peak at λ_{blue phase}=640 nm [27] (FIG. 2D) and by the corresponding macroscopic pictures of the PDA-SF suspensions (FIG. 2F); for t≥2 min the PDA-SF red phase starts to form as shown by the increased absorbance at λ_{red phase}=540 nm; the colorimetric transition is complete for exposure times of t=180 min with the suspension turning completely red. Comparing the activation kinetic of the PDA-SF suspension with that of PDA-DMPC it can be noted that the PDA-SF suspension displays a much higher absorption in blue region for the same activation time (PDA-SF 0.48 a.u. vs PDA-DMPC 0.21 a.u. at t=2 min) indicating a higher packing efficiency of PCDA within SF-based sensors. Also, for PDA-DMPC the blue-to-red transition is complete after 10 minutes of UV exposure (with the complete disappearance of the peak at λ_{blue phase}=640 nm); on the contrary, after 3 h of UV exposure of the PDA-SF solution the absorbance at λ_{blue phase}=640 nm is still present, thus suggesting that the SF layer is granting a functional protection due to its absorbance in the UV region limiting the PDA's cross sensitivity and increasing its life span of when exposed to sunlight.

The behavior of the PDA-SF (FIGS. 2E and 2G) and PDA-DMPC vesicles in solid is consistent with what observed in liquid, as confirmed by reflectance measurements and by the corresponding macroscopic pictures. The PDA-SF suspension cast on paper shows a minimum reflectance for λ_{blue phase}=640 nm and the transition to red is accompanied by an increased reflectance in a broad range of wavelengths, λ=550-650 nm. Similarly, from the macroscopic photographs of PDA-SF sensors (FIG. 2G) it can be seen that PDA-SF vesicles undergo only a weak transition to red despite the high UV dose received (27 Jcm⁻²—Table 2), thus indicating an excellent sensor stability toward unselective stimuli (e.g., sunlight) while PDA-DMPC turn completely red after 60 min of UV exposure. Thus, an UV exposure time of t=1 min was chosen to activate the PDA-SF and PDA-DMPC vesicles for mechanochromic sensing applications.

TABLE 2

| Activation | UV dose | Activation | UV dose |
|---|---|---|---|
| time [s]^{a)} | [mJcm⁻²] | time [min] | [mJcm⁻²] |
| 0 | 0 | 2 | 300 |
| 5 | 12.5 | 5 | 750 |
| 10 | 25 | 10 | 1500 |
| 20 | 50 | 60 | 9000 |
| 60 | 150 | 180 | 27000 |

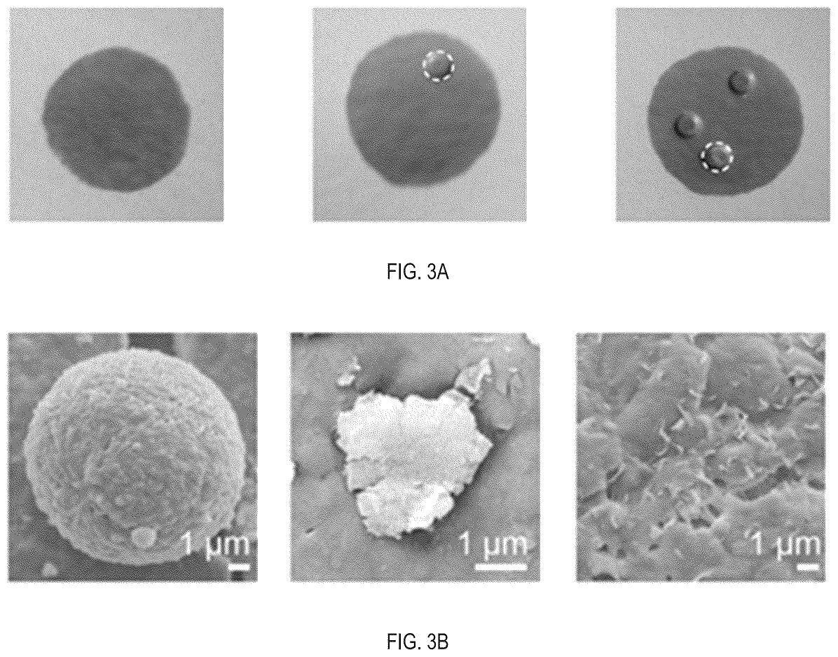

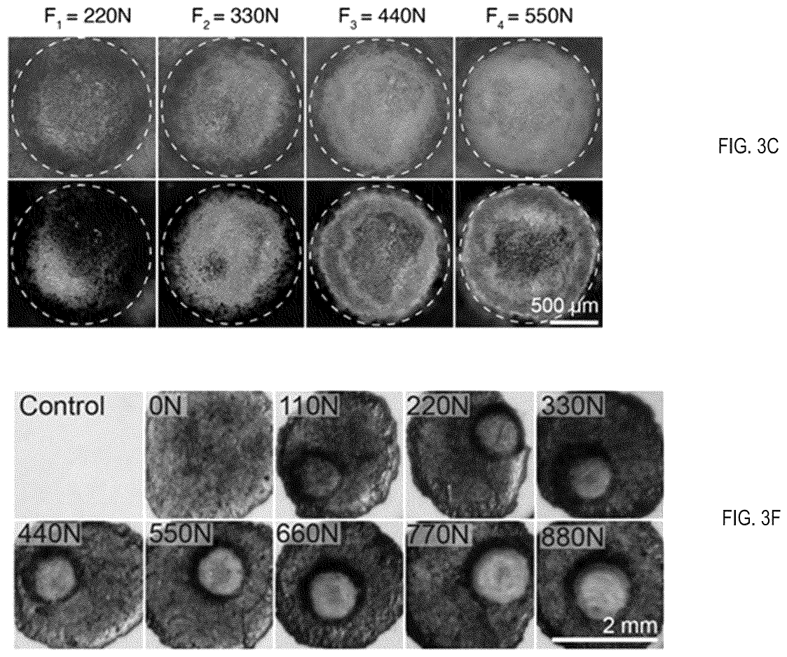

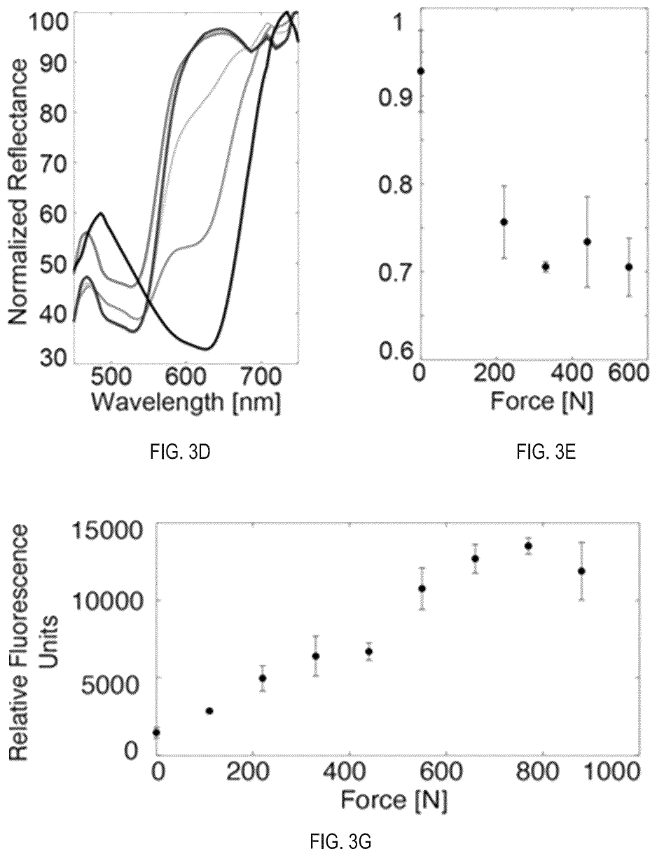

To assess and measure the mechanochromic response of the PDA-SF vesicles, solid format sensors were fabricated by drop casting the suspension on paper substrates to form thin films that were subsequently mechanically activated through the falling of a steel dart (m=450 g) from different heights (FIG. 6). The impact of the dart on the mechanochromic films causes a local color transition that is directly proportional to the impact force (FIG. 3A), is visible at the naked eye, and is limited to the region hit by the dart. The colorimetric response can be correlated to the deformation of the vesicles (FIG. 3B) which show an increase in structural failure for higher energy impacts.

The PDA-SF color transition is measurable via the acquisition of reflectance cubes using brightfield multispectral microscopy (FIGS. 3C-E) and reflectance widefield fluorescence microscopy (FIGS. 3F and 3G). For brightfield analysis, the blue-to-red transition is visible for impacts in the force range F=220-440 N. Lower activation forces cause no visible color transition, while higher forces cause partial destruction of the paper substrate, as shown by the increased presence of white areas in the RGB micrographs of the dart impact regions (FIG. 3C, top row). Multispectral analysis allows a fine discrimination of the regions of the PDA-SF films subjected to different forces during the impact by enabling the collection of the reflectance spectra for every pixel of the acquired cubes. False-color reconstrued micrographs of the impact region (FIG. 3C, bottom row) show how for low forces (F₁=220 N) only a limited region of the impact area actually undergoes the colorimetric transition (FIG. 3D); for intermediate impact forces (F₂=330 N) the entire impact region undergoes the mechanochromic shift with a non-symmetric distribution of the color changes; higher forces (F₃=440 N and F₄=550 N) promote an inward radially increasing color transition with the strongest shift observed in the center of the impact region. By evaluating the ratio of the reflectance intensity of the red phase (I_{red 570nm}) over the blue phase (I_{blue 651nm}), it can be noted that the intensity of the red phase increases for intermediate impact forces despite the decrease at high forces caused by the paper getting damaged (FIG. 3E). For comparison, the mechanical response of PDA-DMPC films to the same falling heights was also analyzed; the paper-based PDA-DMPC sensors display a colorimetric transition that is barely visible at the naked eye and detectable by multispectral analysis probably due to the poor alignment of the PDA within the DMPC aggregates; this demonstrates that SF also improves the colorimetric response of the vesicles compared to those synthetized using DMPC.

The blue-to-red color transition of PDA visible in brightfield reflectance is accompanied by a variation of the fluorescent properties as the PDA red phase is fluorescent (λ_{Em}=650 nm) while the blue phase is not. Therefore, this mechanochromic transition can be analyzed also through fluorescent reflectance microscopy which reveals a broader sensing range of F=100-770 N (FIGS. 3F and 3G). For impact forces higher than F=770 N, the fluorescence response is still detectable, but it is affected by the partial destruction of the paper substrate, which causes a decrease in the fluorescent signal.

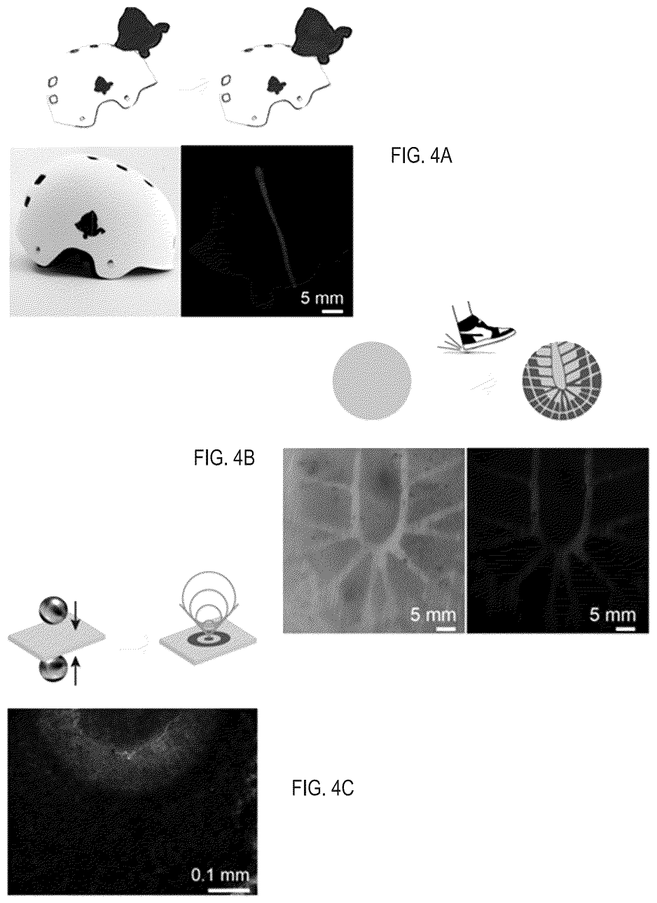

Finally, the versatility of the synthetized PDA-SF mechanochromic sensors is displayed by a series of demonstrator devices along fabricated on a variety of different substrates (FIGS. 4A-C).

We present some examples of applications possible due to the high force range for these sensors as well as some examples of different methods of deposition of SF-PCDA for creating mechanical sensing layers. As first example we have created a mechanochromic sticker (see material section) that can be readily applied to sports related tools such as helmets (FIG. 4A) or golf clubs.

As can be seen in video that can be provided to a patent examiner upon request, the sticker displays locally a visible color transition where the force was delivered, and considering the high impact sensitivity range, it can be a simple sensor for early detection of concussions in professional or recreative football and related sports that make use of body armors and helmets.

Applying the sticker to a golf club and hitting a ball generates a residual image of the impact on the sticker allowing in field quantification by measuring the blue circles from the golf ball pattern. Moreover, the shape of the circles also gives information about the impact angle between the ball and the club as can it be seen by the different pattern imprinted on a 5 iron and a pitching wedge.

Thanks to the SF protective layer, PDA-SF vesicles are also more resistant than PDA-DMPC vesicles and better suited for manufacturing. Indeed, in FIG. 4B we show further an additional application and alternative substrate for vesicle's deposition as well. As described in materials section, we have casted a layer of mechanochromic vesicles onto polystyrene and stomping the polystyrene sheet (with vesicles layer facing the ground) causes a naked-eye visible color transition that perfectly reproduce the sole pattern. Such impact memory material could be useful for have a visual quantification of the ground reaction forces whose measure is traditionally performed using force plates constrained in fixed laboratory settings.

As another example, elaborated upon below, we report for the first time colorimetric detection of a shockwave.

In conclusion, we have presented a straightforward high-scale method to create core-shell structures made of SF and PDA to be employed as colorimetric impact sensor.

The SF microbeads showed both excellent deposition properties on paper and colorimetric response toward mechanical stimuli. Compared to the commonly employed PDA-DMPC, the addition of SF grants the formation of an external protecting layer that increase sensor's colorimetric response and stability. Due to these improvements, PDA-SF mb were here tested and characterized as a quantitative impact sensor for the first time. The naked-eye working range of the sensor is between 220 and 440 N which fits in highest and unreported range for colorimetric mechanical sensors.

The sensor's response is visible to the naked eye and can be quantified through spectral mapping offering the first example of a quantitative impact colorimetric sensor.

Last but not least, SF-PCDA sensor displayed improved quality of deposition and manufacturing while maintaining their ability to respond to stimuli thus widening their applications for cheap sensing layers.

### Example 2. Large Scale Synthesis

Above, we detailed the synthesis and purification procedure for core-shell microparticles derived from silk fibroin and pentacosadienoic acid. In this example, we scaled up the synthesis to larger volumes (approximately 1 liter) and simplified the process to calculate yield and estimate the potential sensor cost.

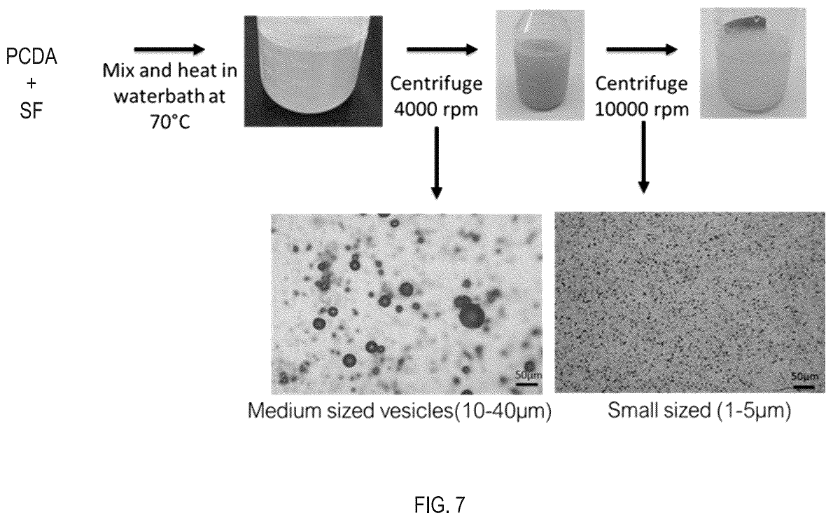

As depicted in FIG. 7, silk and PCDA are mixed and heated in a water bath at 70° C. for about 30 minutes while vigorously agitating the solution. This yields a milky white-pink suspension, which is initially passed through a sieve to remove larger aggregates and then filtered with a 40 μm nylon filter. Subsequently, a first centrifugation at 4000 rpm for 30 minutes allows the recovery of larger-sized sensors (10-40 μm) from the pellet.

The supernatant, a white colloidal solution, undergoes a second centrifugation at 10,000 rpm for 8 hours. This step enables the quantitative recovery of the remaining suspended particles, forming a white-blue pellet composed of small-sized sensors (1-5 μm) and a transparent straw-yellow supernatant containing unreacted silk.

Several combinations were tested, and the one that yielded the best results involved using a concentration of 2.5% silk fibroin with a molecular weight of 45 kDa and a concentration of 0.25% pentacosadienoic acid (PCDA) (SF: PCDA 10:1). From the calculations, the overall yield of the described process is 18.4% (±0.4%), comprising 5.4% (±0.9%) medium-sized vesicles and 13% (±0.9%) small vesicles. Process losses (81.6%±0.4%) include 5.9% (±0.8%) of precipitates and aggregates lost during filtration processes, and 75.2% (±0.8%) of unreached silk solution that could be recovered as the supernatant from the final centrifugation and utilized in a subsequent batch.

Considering the Sigma-Aldrich price of polydiacetylene and assigning a cost of $1/g to silk fibroin, the estimated cost for these sensors is approximately $6/g. 7.5 g of silk ($1/g) and 750 mg PCDA ($16.60 at Sigma-Aldrich price) yields 1.52 g of PDA sensors with a total yield of 18.4%±0.4%. The total yield can be broken down into a yield of small particles of 13%±0.9% and a yield of medium particles of 5.4%±0.9%.

Both medium-sized and small-sized sensors exhibit mechanochromism and respond with the same activation threshold, although medium-sized sensors provide a darker color, likely due to a higher polydiacetylene content. However, medium-sized sensors do not form colloidal solutions; instead, they tend to precipitate within a few hours. Additionally, small-sized vesicles tend to form more homogeneous coatings, especially when observed at slight magnifications.

### Example 3. Functional Textiles and Other Wearables

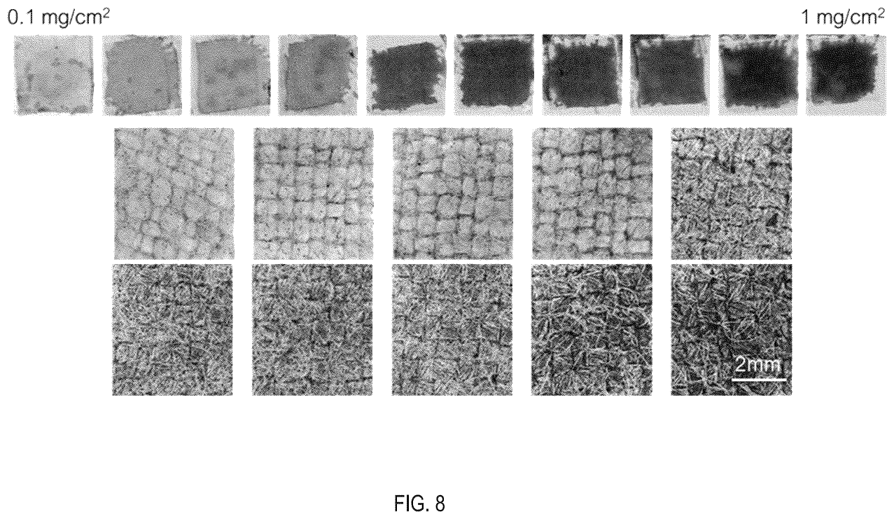

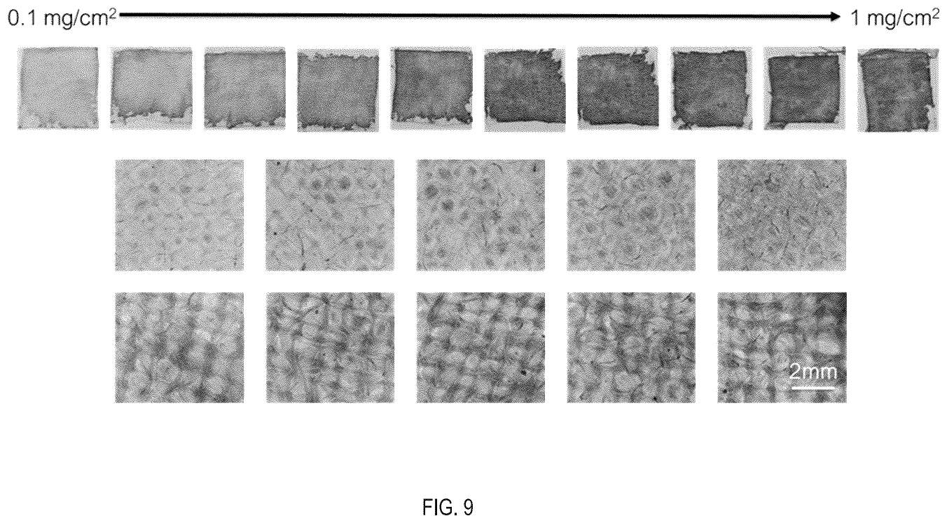

In FIGS. 8 and 9, textile (cotton) coatings are shown (spray-coated) with different densities (0.1-1 mg/cm²) of medium and small-sized vesicles, respectively. The final color obtained varies from material to material, especially with absorbent materials. However, for fabrics, a quantity of 1 mg/cm² seems sufficient to provide a relatively intense and uniform blue. The estimated cost for a density of 1 mg/cm² is $60/m².

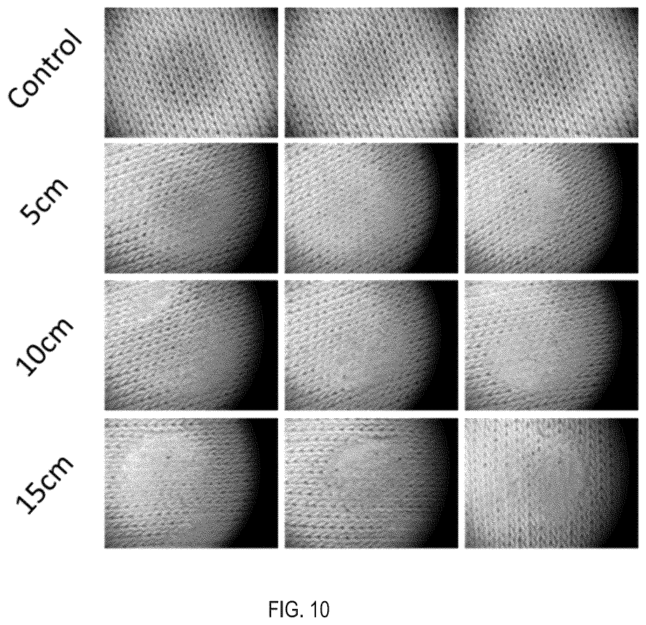

In FIG. 10, photos taken with a mobile microscope on a mechanochromic textile at the impact point of a 540 g dart with a flat, circular tip (diameter: 4 mm) dropped from heights of 5, 10, and 15 cm are shown.

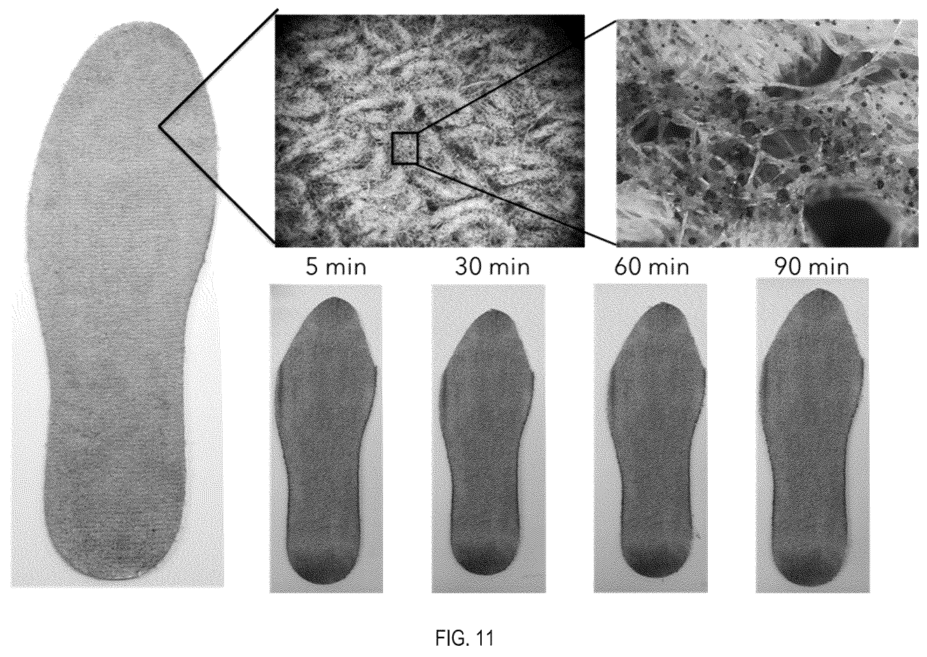

Apart from intense impacts, the sensors also respond to lighter mechanical stimuli caused by friction, prompting us to explore other potential applications. For instance, we coated an insole with a layer of sensors and walked for an hour and a half, capturing images at 30-minute intervals, as shown in FIG. 11. A podiatrist or other skilled medical provider can interpret the activation pattern to deduce whether or not it contains useful biomedical or orthopedic information.

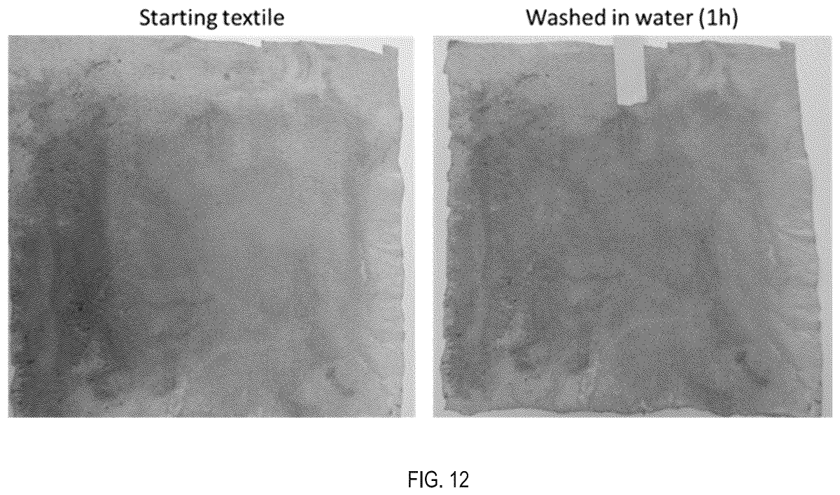

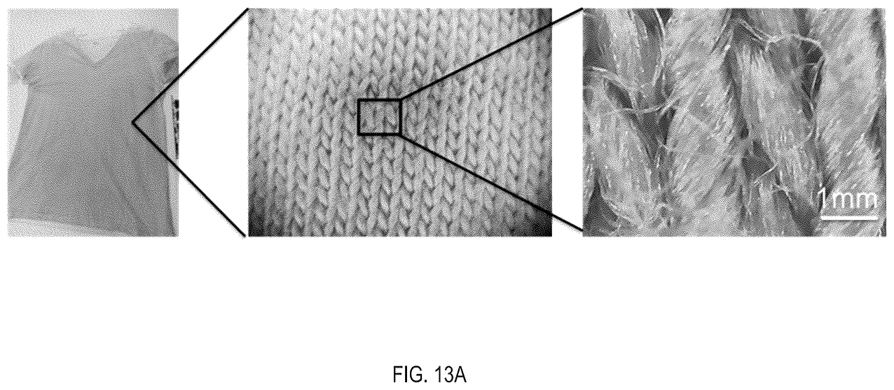

We also tested the stability of the sensors through water rinsing. Rinsing with water for 1 hour under gentle shaking retained sensor activity, as shown by the images in FIG. 12.

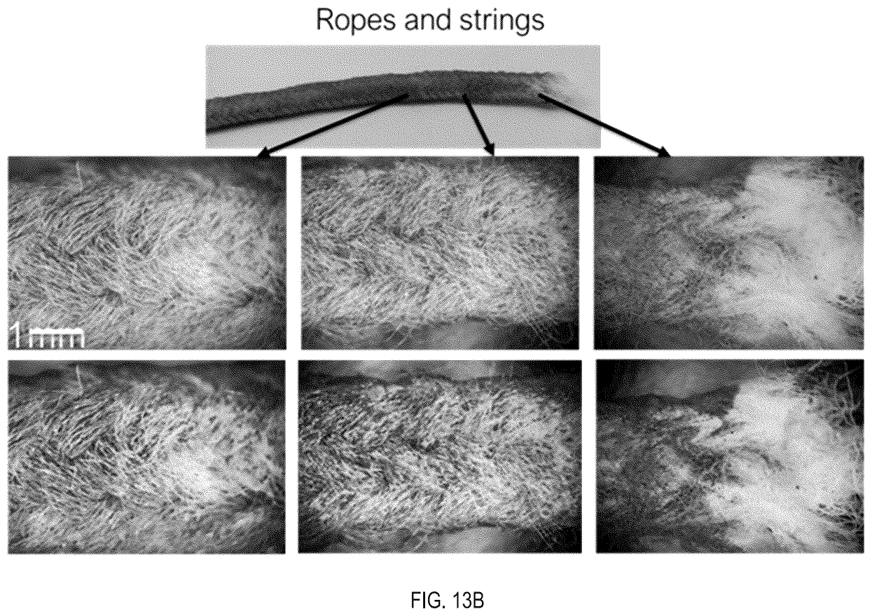

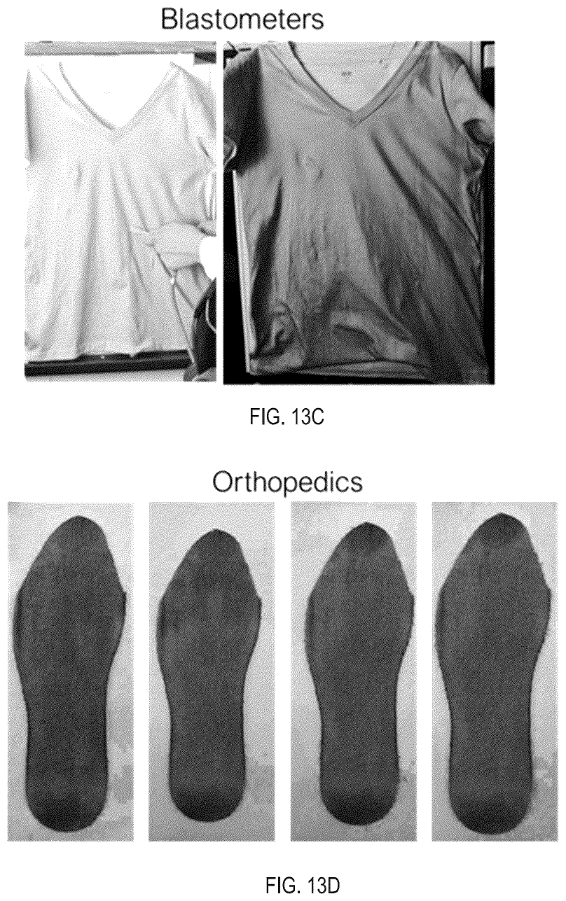

In FIGS. 13A-D, images of functionalized articles are provided, including a shirt (FIGS. 13A and 13C), climbing ropes (FIG. 13B), and orthopedic inserts (FIG. 13D). To observe blast forces (FIG. 13C), a nipple was inflated near a shirt and allowed to explode, thereby providing a small blast force.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

In addition to the features described above and elsewhere herein, the present disclosure also includes the following clauses:
1. A colorimetric mechanochromic sensor that is responsive to a blunt force impact, the sensor comprising one or more core-shell vesicles, each of the one or more core-shell vesicles comprising:
   a core comprising or consisting of crystalline polyacetylene; and
   a shell material layer at least partly surrounding the core, the shell material layer comprising silk fibroin,
each of the one or more core-shell vesicles having a first characteristic colorimetric property, wherein the sensor is colorimetrically responsive to the blunt force impact by virtue of change in the crystal structure of the crystalline polyacetylene, thereby producing an observable and/or measurable change in the first characteristic colorimetric property for any of the one or more core-shell vesicles impacted by the blunt force impact;
wherein the first characteristic colorimetric property is selected from the group consisting of a color of the core-shell vesicle, a fluorescence spectrum of the core-shell vesicle, an optical anisotropy of the core-shell vesicle, a fluorescence anisotropy of the core-shell vesicle, a refractive index of the core-shell vesicle, an infrared spectrum of the core-shell vesicle, a near infrared spectrum of the core-shell vesicle, a morphology of the core-shell vesicle, a Raman spectrum of the core-shell vesicle, an x-ray diffraction spectrum of the core-shell vesicle, and combinations thereof.
2. A colorimetric thermal sensor that is responsive to temperature exceeding a predetermined temperature threshold, the sensor comprising:
   a core comprising or consisting of crystalline polyacetylene; and
   a shell material layer at least partly surrounding the core, the shell material layer comprising silk fibroin,
each of the one or more core-shell vesicles having a first characteristic colorimetric property, wherein the sensor is colorimetrically responsive to the temperature exceeding the predetermined temperature threshold by virtue of change in the crystal structure of the crystalline polyacetylene; wherein the first characteristic colorimetric property is selected from the group consisting of a color of the core-shell vesicle, a fluorescence spectrum of the core-shell vesicle, an optical anisotropy of the core-shell vesicle, a fluorescence anisotropy of the core-shell vesicle, a refractive index of the core-shell vesicle, an infrared spectrum of the core-shell vesicle, a near infrared spectrum of the core-shell vesicle, a morphology of the core-shell vesicle, a Raman spectrum of the core-shell vesicle, an x-ray diffraction spectrum of the core-shell vesicle, and combinations thereof.
3. A colorimetric thermal and mechanical impact sensor, the sensor comprising:
   a crystalline polyacetylene core; and
   a shell material layer at least partly surrounding the polyacetylene core, the shell material layer comprising silk fibroin,
each of the one or more core-shell vesicles having a first characteristic colorimetric property, wherein the sensor is colorimetrically responsive to the temperature and/or blunt force impact by virtue of change in the crystal structure of the crystalline polyacetylene core, thereby producing an observable and/or measurable change in the first characteristic colorimetric property for any of the one or more core-shell vesicles impacted by the temperature and/or blunt force impact; wherein the first characteristic colorimetric property is selected from the group consisting of a color of the core-shell vesicle, a fluorescence spectrum of the core-shell vesicle, an optical anisotropy of the core-shell vesicle, a fluorescence anisotropy of the core-shell vesicle, a refractive index of the core-shell vesicle, an infrared spectrum of the core-shell vesicle, a near infrared spectrum of the core-shell vesicle, a morphology of the core-shell vesicle, a Raman spectrum of the core-shell vesicle, an x-ray diffraction spectrum of the core-shell vesicle, and combinations thereof.
4. The sensor of clause 2 or 3, wherein the predetermined temperature threshold is between 40° C. and 60° C.
5. A colorimetric mechanochromic sensor precursor comprising:
   a core comprising non-crystalline acetylene monomers; and
   a shell material layer at least partly surrounding the core, the shell material layer comprising silk fibroin.
6. A colorimetric thermal sensor precursor comprising:
   a core comprising non-crystalline acetylene monomers; and
   a shell material layer at least partly surrounding the core, the shell material layer comprising silk fibroin.
7. A colorimetric thermal-mechanochromic sensor precursor comprising:
   a core comprising non-crystalline acetylene monomers; and
   a shell material layer at least partly surrounding the core, the shell material layer comprising silk fibroin.
8. The precursor of any one of clauses 5 to 7, wherein applying ultraviolet (UV) light to the precursor produces the sensor of any one of clauses 1 to 4.
9. The precursor of any one of clauses 5 to the immediately preceding clause, wherein at least 25% or at least 50% of the core-shell vesicles are converted to the mechanochromic sensor of any one of clauses 1 to 4 after 3 hours of exposure to a UV dose of 27,000 mJ/cm².
10. The sensor or precursor of any one of the preceding clauses, wherein the first characteristic colorimetric property is shelf stable.
11. The sensor or precursor of any one of the preceding clauses, wherein the first characteristic colorimetric property is derived from a reflectance color spectrum of at least a portion of the sensor.
12. The sensor of any one of the preceding clauses, wherein the crystalline polyacetylene comprises a PDA polymer.
13. The sensor of the immediately preceding clause, wherein the PDA polymer is 10,12-pentacosadiynoic acid (PCDA).
14. The sensor of any one of the preceding clauses, wherein the crystalline polyacetylene is a single crystal.
15. The sensor or precursor of any one of the preceding clauses, wherein the shell material layer is a continuous layer surrounding the core.
16. The sensor or precursor of any one of the preceding clauses, wherein each of the one or more core-shell vesicles has a mass ratio of the core to the shell material layer of between 1:1000 and 100:1.
17. The sensor or precursor of any one of the preceding clauses, wherein each of the one or more core-shell vesicles has a diameter of between 0.05 micrometers and 500 micrometers.
18. The sensor or precursor of any one of the preceding clauses, wherein the one or more core-shell vesicles is a plurality of core-shell vesicles having a statistical distribution of one or more properties.
19. The sensor of the immediately preceding clause, wherein the one or more properties includes diameter of the plurality of core-shell vesicles.
20. The sensor of the immediately preceding clause, wherein the statistical distribution of the diameter of the plurality of core-shell vesicles includes a mean diameter of between 1.0 μm and 1 mm, including but not limited to, at least 1.0 μm, at least 1.2 μm, at least 1.5 μm, at least 1.75 μm, at least 2.0 μm, at least 2.5 μm, at least 2.8 μm, at least 3.0 μm, at least 3.5 μm, at least 3.8 μm, at least 4.0 μm, at least 4.5 μm, at least 4.75 μm, at least 5.0 μm, at least 5.5 μm, at least 5.6 μm, at least 6.0 μm, at least 6.5 μm, at least 6.8 μm, at least 7.0 μm, at least 7.5 μm, at least 7.75 μm, at least 8.0 μm, at least 8.5 μm, at least 8.6 μm, at least 9.0 μm, at least 9.5 μm, at least 9.7 μm, at least 10.0 μm, at least 10.5 μm, at least 10.75 μm, at least 11.0 μm, at least 11.5 μm, at least 11.75 μm, at least 12.0 μm, at least 12.5 μm, at least 12.6 μm, at least 13.0 μm, at least 13.5 μm, at least 13.8 μm, at least 14.0 μm, at least 14.5 μm, at least 14.7 μm, at least 15.0 μm, at least 15.5 μm, at least 15.75 μm, at least 16.0 μm, at least 16.5 μm, at least 16.6 μm, at least 17.0 μm, at least 17.5 μm, at least 17.8 μm, at least 18.0 μm, at least 18.5 μm, at least 18.7 μm, at least 19.0 μm, at least 19.5 μm, at least 19.75 μm, at least 20.0 μm, at least 25.0 μm, at least 30.0 μm, at least 35.0 μm, at least 40.0 μm, at least 45.0 μm, at least 50.0 μm, at least 55.0 μm, at least 60.0 μm, at least 65.0 μm, at least 70.0 μm, at least 75.0 μm, at least 80.0 μm, at least 85.0 μm, at least 90.0 μm, at least 95.0 μm, 100 μm, at least 150 μm, at least 200 μm, at least 250 μm, at least 300 μm, at least 350 μm, at least 400 μm, at least 450 μm, at least 500 μm, at least 600 μm, at least 700 μm, at least 800 μm, or at least 900 μm and at most 1 mm, at most 900 μm, at most 800 μm, at most 750 μm, at most 700 μm, at most 650 μm, at most 600 μm, at most 575 μm, at most 550 μm, at most 525 μm, at most 500 μm, at most 450 μm, at most 400 μm, at most 360 μm, at most 350 μm, at most 320 μm, at most 300 μm, at most 240 μm, at most 200 μm, at most 175 μm, at most 150 μm, at most 125 μm, at most 100 μm, at most 92.5 μm, at most 90.0 μm, at most 87.5 μm, at most 85.0 μm, at most 83.0 μm, at most 80.0 μm, at most 75.0 μm, at most 71.5 μm, at most 70.0 μm, at most 67.5 μm, at most 65.0 μm, at most 60.0 μm, at most 55.0 μm, at most 50.0 μm, at most 48.0 μm, at most 45.0 μm, at most 43.5 μm, at most 40.0 μm, at most 37.0 μm, at most 35.0 μm, at most 32.5 μm, at most 30.0 μm, at most 27.5 μm, at most 25.0 μm, at most 22.5 μm, at most 20.0 μm, at most 17.5 μm, at most 15.0 μm, at most 13.0 μm, at most 12.5 μm, at most 11.0 μm, at most 10.0 μm, or at most 5.0 μm.
21. The sensor or precursor of any one of the preceding clauses, the shell material layer defining an inner hydrophobic pocket, in which the core is located, and an outer hydrophilic surface.
22. The sensor or precursor of any one of the preceding clauses, wherein at least one of the one or more core-shell vesicles has a negative zeta potential.
23. The sensor or precursor of any one of the preceding clauses, wherein at least 5%, at least 10%, at least 15%, at least 20%, at least 25%, at least 30%, at least 40%, at least 50%, at least 60%, at least 70%, at least 75%, at least 80%, at least 85%, at least 90%, at least 95%, or each of the one or more core-shell vesicles has a negative zeta potential.
24. The sensor or precursor of any one of the preceding clauses, wherein at least one of the one or more core-shell vesicles has a zeta potential of at most-100 mV.
25. The sensor or precursor of any one of the preceding clauses, wherein the blunt force impact producing the observable and/or measurable change is between 110 N and 700 N.
26. The sensor or precursor of the immediately preceding clause, wherein the first characteristic colorimetric property is the fluorescence spectrum of the core-shell vesicle.
27. The sensor or precursor of the immediately preceding clause, wherein the observable and/or measurable change is the measurable change.
28. The sensor or precursor of any one of the preceding clauses, wherein the blunt force impact producing the observable and/or measurable change is between 220 N and 440 N.
29. The sensor or precursor of any one of the preceding clauses, wherein the observable and/or measurable change is quantitative relative to impact force.
30. The sensor or precursor of the immediately preceding clause, wherein the first characteristic colorimetric property is the color of the core-shell vesicle.
31. The sensor or precursor of the immediately preceding clause, wherein the observable and/or measurable change is the observable change.
32. The sensor or precursor of any one of the preceding clauses, wherein the observable and/or measurable change is observable by a human eye.
33. The sensor or precursor of any one of clause 1 to the clause immediately preceding the immediately preceding clause, wherein the observable and/or measurable change is not observable by a human eye.
34. The sensor or precursor of any one of the preceding clauses, wherein the core makes up between 60% and 98% of the core-shell vesicle diameter.
35. The sensor or precursor of any one of the preceding clauses, wherein the shell material layer makes up between 2% and 40% of the core-shell vesicle diameter.
36. The sensor or precursor of any one of the preceding clauses, wherein at least 50%, at least 75%, at least 90%, or approximately 100% of the one or more core-shell vesicles is spherical in shape.
37. The sensor of any one of the preceding clauses, wherein the one or more core-shell vesicles are embedded in a carrier material.
38. The sensor of the immediately preceding clause, wherein the carrier material is an aqueous solution, a solid, or a lyophilized solid.
39. A device comprising a sensor or precursor of any one of the preceding clauses, the sensor adapted to sense mechanical impact on a portion of the device.
40. A helmet having at least one internal component comprising the sensor or the precursor of any one of clauses 1-37.
41. The helmet of clause 40, wherein the sensor or precursor of any one of clauses 1-37 is applied to the helmet as an adhesive sticker or is applied by spray coating directly on the helmet.
42. The helmet of clause 40, wherein the helmet is a football helmet.
43. The helmet of clause 40, wherein the helmet is a bicycle helmet.
44. The helmet of clause 40, wherein the helmet is a hockey helmet.
45. The helmet of clause 40, wherein the helmet is a baseball helmet.
46. The helmet of clause 40, wherein the helmet is a safety helmet.
47. The helmet of any one of clauses 40 to 46, wherein the helmet is dimensioned to fit the cranium of a human baby having cranial dimensions falling within two standard deviations of the mean of a statistically significant population of human babies.
48. The helmet of any one of clauses 40 to 46, wherein the helmet is dimensioned to fit the cranium of a human infant having cranial dimensions falling within two standard deviations of the mean of a statistically significant population of human infants.
49. The helmet of any one of clauses 40 to 46, wherein the helmet is dimensioned to fit the cranium of a human toddler having cranial dimensions falling within two standard deviations of the mean of a statistically significant population of human toddlers.
50. The helmet of any one of clauses 40 to 46, wherein the helmet is dimensioned to fit the cranium of a human child having cranial dimensions falling within two standard deviations of the mean of a statistically significant population of human children.
51. The helmet of any one of clauses 40 to 46, wherein the helmet is dimensioned to fit the cranium of a human adult having cranial dimensions falling within two standard deviations of the mean of a statistically significant population of human adults.
52. The helmet of any one of clauses 40 to 46, wherein the sensor or precursor is located in a plastic portion of the helmet.
53. The helmet of any one of clauses 40 to 46, wherein the sensor or precursor is located in a foam padding portion of the helmet.
54. An elbow guard or elbow protector having at least one internal component comprising the sensor or precursor of any one of clauses 1-37.
55. A knee guard or knee protector having at least one internal component comprising the sensor or precursor of any one of clauses 1-37.
56. A wrist guard or wrist protector having at least one internal component comprising the sensor or precursor of any one of clauses 1-37.
57. A shin guard or shin protector having at least one internal component comprising the sensor or precursor of any one of clauses 1-37.
58. A glove having at least one internal component having at least one internal component comprising the sensor or precursor of any one of clauses 1-37.
59. The glove of clause 57, wherein the glove is a boxing glove.
60. The glove of clause 57, wherein the glove is a mixed martial arts glove.
61. A shoe having at least one internal component comprising the sensor or precursor of any one of clauses 1-37.
62. The shoe of the immediately preceding clause, wherein the sensor or precursor is located in a sole of the shoe.
63. An article of clothing having at least one internal component comprising the sensor or precursor of any one of clauses 1-37.
64. A golf club having a striking face, wherein at least a portion of the striking face comprises the sensor or precursor of any one of clauses 1-37.
65. A packaging material comprising the sensor or precursor of any one of clauses 1-37.
66. A shipping container comprising the sensor or precursor of any one of clauses 1-37.
67. A shipping box comprising the sensor or precursor of any one of clauses 1-37.
68. An adhesive sheet comprising the sensor or precursor of any one of clauses 1-37.
69. A roll of adhesive tape comprising the sensor or precursor of any one of clauses 1-37.
70. A vehicle having at least one internal component comprising the sensor or precursor of any one of clauses 1-37.
71. A vehicular component comprising the sensor or precursor of any one of clauses 1-37.
72. A bumper for a vehicle comprising the sensor or precursor of any one of clauses 1-37.
73. A body armor comprising the sensor or precursor of any one of clauses 1-37.
74. A protective equipment comprising the sensor or precursor of any one of clauses 1-37.
75. A suitcase comprising the sensor or precursor of any one of clauses 1-37.
76. A friction sensing product comprising the sensor or precursor of any one of clauses 1-37.
77. An aerodynamic observation paint comprising the sensor or precursor of any one of clauses 1-37.
78. A sporting ball comprising the sensor or precursor of any one of clauses 1-37.
79. A baseball bat comprising the sensor or precursor of any one of clauses 1-37.
80. An impact dampening foam comprising the sensor or precursor of any one of clauses 1-37.
81. An insurance evaluation tool including a paint comprising the sensor or precursor of any one of clauses 1-37, wherein the tool is optionally used to estimate impacts on an individual for the purpose of an insurance clause.
82. An device comprising an interior sensing element comprising the sensor or precursor of any one of clauses 1-37, where the sensor or precursor is not visible during use and requires opening the device to access the sensor or precursor.
83. A ballistic gel comprising the sensor or precursor of any one of clauses 1-37.
84. A mechanical gear comprising the sensor or precursor of any one of clauses 1-37 distributed throughout or on an exterior surface.
85. A rope, cord, and/or string comprising the sensor or precursor of any one of clauses 1-37.
86. Rope hardware and/or rock climbing hardware comprising the sensor or precursor of any one of clauses 1-37.
87. A boating cleat comprising the sensor or precursor of any one of clauses 1-37.
88. A threaded solid part, optionally a threaded metal part, comprising the sensor or precursor of any one of clauses 1-37 on the threading.
89. A gaming target comprising the sensor or precursor of any one of clauses 1-37, wherein the gaming target has a single force threshold is within a predefined range.
90. A precision force sensing target that shows a specific signal when a precise force is applied (i.e., a game where you need to hit within a specific range) comprising the sensor or precursor of any one of clauses 1-37, wherein at least two different sensors or precursors are present having different force thresholds, thereby producing the specific signal.
91. A particle board comprising the sensor or precursor of any one of clauses 1-37, wherein the particle board comprises a filler and a binder, wherein the sensor or precursor is optionally embedded within the binder.
92. A semiconductor processing coating comprising the sensor or precursor of any one of clauses 1-37.
93. An automated machining observation coating comprising the sensor or precursor of any one of clauses 1-37, wherein the coating is on either the part or the robot.
94. A quality control paint comprising the sensor or precursor of any one of clauses 1-37.
95. A 3D reporting foam for personalized gait analysis for a runner comprising the sensor or precursor of any one of clauses 1-37.
96. A coating on a carbon-fiber part comprising the sensor or precursor of any one of clauses 1-37, wherein the carbon-fiber part is optionally a car part, wherein the car part is optionally a chassis.
97. A glass impact sensor comprising the sensor or precursor of any one of clauses 1-37.
98. A crash-test dummy comprising a silk-PDA sensor.
99. A cosmetic comprising a silk-PDA sensor.
100. A drone delivery bag comprising the sensor or precursor of any one of clauses 1-37.
101. A forklift comprising the sensor or precursor of any one of clauses 1-37.
102. A shelf comprising the sensor or precursor of any one of clauses 1-37.
103. A sensor-infused cardboard having a plurality of the sensor or precursor of any one of clauses 1-37 distributed throughout.
104. A tamper-proof tape assembly comprising a plurality of layers, each of the plurality of layers including the sensor or precursor of any one of clauses 1-37, wherein each of the plurality of layers has a different force threshold, wherein the plurality of layers is optionally not visible until removal of topping layers.
105. An impact sensing coating comprising the sensor or precursor of any one of clauses 1-37, wherein the coating comprises a conformal foam that is optionally sprayable.
106. A sprayable foam comprising the sensor or precursor of any one of clauses 1-37.
107. A gasket coating comprising the sensor or precursor of any one of clauses 1-37.
108. An aerospace impact reporting coating comprising the sensor or precursor of any one of clauses 1-37.
109. A system for recording and measuring mechanical impact, the system comprising:
   a camera;
   a processor; and
   a memory, wherein the system is usable with the sensors or methods described herein.
110. A method of making a plurality of core-shell vesicles, the method comprising: mechanically agitating a water-based solution of silk fibroin and PCDA at an elevated temperature to produce a composition comprising a plurality of core-shell vesicles.
111. The method of the immediately preceding clause, wherein mechanically agitating is performed by sonication, vigorous stirring, or with a blender.
112. The method of either of the two immediately preceding clauses, the method further comprising centrifuging the composition comprising the plurality of core-shell vesicles to at least partially isolate one or more individual components, including but not limited to aggregates of vesicles, unintended waste products, and the like, from the composition.
113. The method of any of the three immediately preceding clauses, the method further comprising size-selecting the plurality of core-shell vesicles to produce a subset of core-shell vesicles having predetermined size properties.
114. The method of any of the four immediately preceding clauses, wherein size-selecting the plurality of core-shell vesicles to produce a subset of core-shell vesicles is accomplish by cyclonic mass separation, fluidic size separators, gradient centrifugation, microfluidic sorting, oscillating shape sorting, or light scattering sorting (i.e., flow cytometry).
115. The method of any one of the five immediately preceding clauses, wherein the method has a mass yield of producing the plurality of core-shell vesicles from the silk fibroin and the PCDA of at least 50%, at least 55%, at least 65%, or at least 70% or greater.
116. A method of using a colorimetric mechanochromic sensor, the method comprising: striking the colorimetric mechanochromic sensor of any one of clauses 1-37, thereby initiating a change in the first characteristic colorimetric property.
117. A method of activating a sensor precursor to produce a sensor, the method comprising exposing the precursor of any one of clauses 5-37 to ultraviolet light at a predetermined exposure intensity for a predetermined length of time.
118. The method of the immediately preceding clause, wherein the precursor is exposed to ultraviolet light for 1-600 seconds.
119. The method of either of the two immediately preceding clauses, wherein the precursor is exposed to an ultraviolet dose of no less than 10-200 mJ/cm².
120. The method of any one of the three immediately preceding clauses, wherein the ultraviolet light has a wavelength of 254 nm.
121. A method of analyzing an image to produce a mechanochromic impact map for an article comprising the colorimetric mechanochromic impact sensor of any one of clauses 1-37, the method comprising:
   assessing a pre-impact image for the presence of the first characteristic colorimetric property;
   assessing a post-impact image for the presence of the first characteristic colorimetric property;
   generating the mechanochromic impact map from a difference in the first characteristic colorimetric property between a pre-impact image and a post-impact image.

1. A colorimetric mechanochromic, thermal, and/or mechanochromic and thermal sensor that is responsive to a blunt force impact, temperature exceeding a predetermined temperature threshold, and/or both, the sensor comprising one or more core-shell vesicles, each of the one or more core-shell vesicles comprising:
a core comprising or consisting of crystalline polyacetylene; and
a shell material layer at least partly surrounding the core, the shell material layer comprising silk fibroin,
each of the one or more core-shell vesicles having a first characteristic colorimetric property, wherein the sensor is colorimetrically responsive to the blunt force impact by virtue of change in the crystal structure of the crystalline polyacetylene, thereby producing an observable and/or measurable change in the first characteristic colorimetric property for any of the one or more core-shell vesicles impacted by the blunt force impact;
wherein the first characteristic colorimetric property is selected from the group consisting of a color of the core-shell vesicle, a fluorescence spectrum of the core-shell vesicle, an optical anisotropy of the core-shell vesicle, a fluorescence anisotropy of the core-shell vesicle, a refractive index of the core-shell vesicle, an infrared spectrum of the core-shell vesicle, a near infrared spectrum of the core-shell vesicle, a morphology of the core-shell vesicle, a Raman spectrum of the core-shell vesicle, an x-ray diffraction spectrum of the core-shell vesicle, and combinations thereof.

2. (canceled)

3. (canceled)

4. The sensor of claim 1, wherein the predetermined temperature threshold is between 40° C. and 60° C.

5. A colorimetric mechanochromic, thermal, and/or mechanochromic and thermal sensor precursor comprising:
a core comprising non-crystalline acetylene monomers; and
a shell material layer at least partly surrounding the core, the shell material layer comprising silk fibroin.

6.-9. (canceled)

10. The sensor of claim 1, wherein the first characteristic colorimetric property is shelf stable, and/or wherein the first characteristic colorimetric property is derived from a reflectance color spectrum of at least a portion of the sensor.

11. (canceled)

12. The sensor of claim 1, wherein the crystalline polyacetylene comprises a PDA polymer.

13. The sensor of claim 12, wherein the PDA polymer is 10,12-pentacosadiynoic acid (PCDA).

14. The sensor of claim 1, wherein the crystalline polyacetylene is a single crystal.

15. The sensor of claim 1, wherein the shell material layer is a continuous layer surrounding the core-, and/or wherein each of the one or more core-shell vesicles has a mass ratio of the core to the shell material layer of between 1:1000 and 100:1, and/or wherein each of the one or more core-shell vesicles has a diameter of between 0.05 micrometers and 500 micrometers, and/or wherein the one or more core-shell vesicles is a plurality of core-shell vesicles having a statistical distribution of one or more properties.

16. (canceled)

17. (canceled)

18. The sensor of claim 1, wherein the one or more core-shell vesicles is a plurality of core-shell vesicles having a statistical distribution of one or more properties, optionally wherein the one or more properties include diameter of the plurality of core-shell vesicles, optionally wherein the statistical distribution of the diameter of the plurality of core-shell vesicles includes a mean diameter of between 1.0 μm and 1 mm.

19. (canceled)

20. (canceled)

21. The sensor of claim 1, the shell material layer defining an inner hydrophobic pocket, in which the core is located, and an outer hydrophilic surface.

22. The sensor of claim 1, wherein at least one of the one or more core-shell vesicles has a negative zeta potential, optionally wherein at least one of the one or more core-shell vesicles has a zeta potential of at most-100 m V.

23. (canceled)

24. (canceled)

25. The sensor of claim 1, wherein the blunt force impact producing the observable and/or measurable change is between 110 N and 700 N, optionally wherein the first characteristic colorimetric property is the fluorescence spectrum of the core-shell vesicle.

26. (canceled)

27. (canceled)

28. The sensor of claim 1, wherein the blunt force impact producing the observable and/or measurable change is between 220 N and 440 N.

29. The sensor of claim 1, wherein the observable and/or measurable change is quantitative relative to impact force.

30. The sensor of claim 1, wherein the first characteristic colorimetric property is the color of the core-shell vesicle.

31. (canceled)

32. The sensor of claim 1, wherein the observable and/or measurable change is observable by a human eye.

33. The sensor of claim 1, wherein the observable and/or measurable change is not observable by a human eye.

34. The sensor of claim 1, wherein the core makes up between 60% and 98% of a core-shell vesicle diameter, wherein the shell material layer makes up between 2% and 40% of the core-shell vesicle diameter.

35. (canceled)

36. (canceled)

37. The sensor of claim 1, wherein the one or more core-shell vesicles are embedded in a carrier material.

38. (canceled)

39. A device comprising the sensor of claim 1, the sensor adapted to sense mechanical impact and/or temperature on a portion of the device.
